(19) United States
(12) Patent Application Publication
(10) Pub. No.: US 2010/0082137 A1
(43) Pub. Date: Apr. 1, 2010

(54) CONTENT SETTING VALUE INFORMATION ACQUIRING DEVICE, CONTENT OUTPUT SYSTEM, CONTENT SETTING VALUE INFORMATION ACQUIRING METHOD, ITS PROGRAM, AND RECORDING MEDIUM ON WHICH ITS PROGRAM IS RECORDED

(75) Inventors: Masahiro Suzuki, Kanagawa (JP); Osamu Santou, Kanagawa (JP); Kazunori Ochiai, Chiba (JP); Yutaka Ikeda, Tokyo (JP); Kenji Okumichi, Saitama (JP); Masakatsu Fujimoto, Kanagawa (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 12/532,749

(22) PCT Filed: Mar. 27, 2007
(86) PCT No.: PCT/JP2007/056400

§ 371 Date: Oct. 26, 2009

(51) Int. Cl. G06F 15/16; G06F 17/00

(52) U.S. Cl. 700/94; 709/217

(57) ABSTRACT

A server of a content output system acquires a user parameter registration information including a user name of a display and a title of a request content. When an image-quality and sound-quality optimum parameter is included, the server acquires the image-quality and sound-quality optimum parameter as a user's user setting information. When the server cannot acquire the user's user setting information, the server retrieves a user parameter registration information including a user name of another person and the title of the request content. When the image-quality and sound-quality optimum parameter is included in the user parameter registration information and an image-quality and sound-quality optimum parameter relating to other contents corresponds to an image-quality and sound-quality optimum parameter relating to other contents of a user requesting an image-quality and sound-quality optimum parameter, the server acquires an image-quality and sound-quality optimum parameter of the another person relating to the request content as an another person's user setting information. Then, the server transmits the user's user setting information or another person's user setting information to the display.

### TECHNICAL FIELD

The present invention relates to a content set value information acquiring device, a content output system, a content set value information acquiring method, a program thereof and a recording medium on which the program is recorded for acquiring a content set value information relating to a content set value indicating an output mode of a content to be outputted by an output unit based on a content data and transmitting the content set value information to an output mode controller that controls the output mode.

### BACKGROUND ART

Arrangements for appropriately adjusting quality of an image displayed by a display unit and quality of sound outputted by a sound output unit have been known (for instance, see Patent Document 1 and Patent Document 2).

According to Patent Document 1, a parameter set value of image quality and sound quality during reproduction is recorded based on settings inputted by a user for every genre information of a program to be reproduced. Then, an image and sound of quality based on the parameter set value are outputted during reproduction.

According to Patent Document 2, a conversion table corresponding to characteristics of a projector, a screen and a theater is downloaded to adjust image quality in accordance with the purpose of a movie director.

[Patent Document 1] JP-A-2005-302119

[Patent Document 2] U.S. Pat. No. 6,771,323

### DISCLOSURE OF THE INVENTION

### Problems to Be Solved by the Invention

However, according to the arrangement disclosed in Patent Document 1, a user is required to set a parameter set value by himself every time the user views a new content, which may be cumbersome. Also, according to the arrangement disclosed in Patent Document 2, a displayed image may not suit viewer's preference because image quality is adjusted in accordance with the purpose of a movie director.

An object of the invention is to provide a content set value information acquiring device, a content output system, a content set value information acquiring method, a program thereof and a recording medium on which the program is recorded for outputting a content of an output mode that meets viewer's preference without complicated operation.

### Means for Solving the Problems

According to an aspect of the invention, a content set value information acquiring device for acquiring a content set value information relating to a content set value indicating an output mode of a content outputted by an output unit based on content data and for transmitting the content set value information to an output mode controller that controls the output mode includes: a request information acquirer that acquires a request information relating to the content outputted by the output unit; a user information acquiring processor for acquiring an output mode registration information of which an information relating to the content and associated with a user of a predetermined output unit corresponds to the request information from an output mode registration information storage that stores the output mode registration information, the output mode registration information including the information relating to the content and an output mode of the content and being associated with the user of the output unit; an another person's information acquiring processor for acquiring the output mode registration information of which the information relating to the content and associated with another person of another output unit when recognizing that the informations relating to the output mode of the output mode registration information and associated with the user of the output unit and the another person of the another output unit in which the information relating to the content does not correspond to the request information substantially correspond to each other; a content set value information generator for generating the content set value information based on the output mode registration information acquired by the user information acquiring processor or the another person's information acquiring processor; and a content set value information transmitter for transmitting the content set value information generated by the content set value information generator to the output mode controller corresponding to the request information.

A content output system according to another aspect of the invention includes: a plurality of output devices connected to receive and transmit various information via a network and including the content set value information acquiring device as described above, in which each of the output devices includes: the output unit; the output mode controller; and the output mode registration information storage that stores the output mode registration information associated with the user of the output unit, the user information acquiring processor acquires the output mode registration information from the output mode registration information storage, and the another person's information acquiring processor acquires the output mode registration information from the output mode registration information storage of another output device.

A content output system according to still another aspect of the invention includes: the content set value information acquiring device as described above; and a plurality of output devices connected to receive and transmit various information via a network from and to the content set value information acquiring device, in which each of the output devices includes: the output unit; the output mode controller; and a request information transmitter for transmitting the request information to the content set value information acquiring device via the network. Further, the content set value information acquiring device includes the output mode registration information storage that stores the output mode registration information associated with users of the plurality of output devices, and the content set value information transmitter transmits the content set value information to the output devices that has transmitted the request information via the network.

A content output system according to still another aspect of the invention includes: the content set value information acquiring device as described above; and a plurality of output devices connected to receive and send various information via a network from and to the content set value information acquiring device, in which each of the output devices includes: the output unit; the output mode controller; and a request information transmitter for transmitting the request information including an information relating to a type of the output unit to the content set value information acquiring device via the network. Further, the content set value acquiring device includes: the output mode registration information storage that stores the output mode registration information including an information relating to a content converted value obtained by converting the content set value based on a registration conversion formula as an information relating to the output mode and associated with users of the plurality of the output devices; and an output conversion information storage that stores an output conversion information including an information relating to a type of the output unit and an output conversion formula for converting the content converted value to the content set value, the content set value information generator generates the content set value information based on: the output conversion formula of the output conversion information of which the information relating to the type of the output unit corresponds to the request information; and the content converted value of the output mode registration information, and the content set value information transmitter transmits the content set value information to the output device that has transmitted the request information via the network.

According to still another aspect of the invention, a content set value information acquiring method is performed for acquiring a content set value information relating to a content set value indicating an output mode of a content outputted by an output unit based on content data and for transmitting the content set value information to an output mode controller that controls the output mode by a computer. The computer performs the method including: acquiring a request information relating to the content outputted by the output unit; acquiring an output mode registration information of which an information relating to the content and associated with a user of the output unit corresponds to the request information from an output mode registration information storage that stores the output mode registration information including an information relating to the content and an output mode of the content and associated with the user of the output unit; acquiring the output mode registration information of which an information relating to the content and associated with an another person of another output unit when recognizing the informations relating to the output mode of the output mode registration information associated with the user of the output unit and the another user of the another output unit in which the information relating to the content does not correspond to the request information substantially correspond to each other; generating the content set value information based on the acquired output mode registration information associated with the user of the output unit or the another user of the another output unit; and transmitting the generated content set value information to the output mode controller corresponding to the request information.

According to still another aspect of the invention, a content set value acquiring program is for operating a computer to execute the content set value information acquiring method as described above.

According to still another aspect of the invention, a content set value information acquiring program is for operating a computer to function as the content set value information acquiring device as described above.

According to still another aspect of the invention, a recording medium on which the content set value information acquiring program according to claim 19 or 20 is recorded in a computer-readable manner.

### BRIEF DESCRIPTION OF DRAWINGS

FIG. 1 is a block diagram schematically showing an arrangement of a content output system according to first to fourth exemplary embodiments of the invention.

FIG. 2 is a block diagram schematically showing an arrangement of a display according to the first to fourth exemplary embodiments.

FIG. 3 is a block diagram schematically showing an arrangement of a server according to the first and second exemplary embodiments.

FIG. 4 schematically shows an arrangement of a user database according to the first exemplary embodiment.

FIG. 5 is a flow chart showing an image-quality and sound-quality adjustment processing according to the first to fourth exemplary embodiments and a fifth exemplary embodiment of the invention.

FIG. 6 is a flowchart showing an image-quality and sound-quality optimum parameter acquisition processing according to the first, second and fifth exemplary embodiments.

FIG. 7 is a flowchart showing a user setting information acquisition processing according to the first to third and fifth exemplary embodiments.

FIG. 8 is a flowchart showing a user's user setting information acquisition processing according to the first and fifth exemplary embodiments.

FIG. 9 is a flowchart showing an another person's user setting information acquisition processing according to the first and second exemplary embodiments.

FIG. 10 schematically shows an arrangement of a user database according to the second exemplary embodiment.

FIG. 11 is a flowchart showing a user's user setting information acquisition processing for the user according to the second to fourth exemplary embodiments.

FIG. 12 is a block diagram schematically showing an arrangement of a server according to the third and fourth exemplary embodiments.

FIG. 13 schematically shows an arrangement of a user database according to the third exemplary embodiment.

FIG. 14 schematically shows an arrangement of an output conversion information database according to the third and fourth exemplary embodiments.

FIG. 15 schematically shows an arrangement of a registration conversion information database according to the third and fourth exemplary embodiments.

FIG. 16 schematically shows an arrangement of a first NR conversion table according to the third and fourth exemplary embodiments.

FIG. 17 schematically shows an arrangement of a second NR conversion table according to the third and fourth exemplary embodiments.

FIG. 18 is a flowchart showing an image-quality and sound-quality optimum parameter acquisition processing according to the third and fourth exemplary embodiments.

FIG. 19 is a flowchart showing an another person's user setting information acquisition processing according to the third exemplary embodiment.

FIG. 20 schematically shows an arrangement of a user-related information database according to the fourth exemplary embodiment.

FIG. 21 schematically shows an arrangement of a user database according to the fourth exemplary embodiment.

FIG. 22 schematically shows an arrangement of a statistical database according to the fourth exemplary embodiment.

FIG. 23 schematically shows an arrangement of a statistical database according to the fourth exemplary embodiment.

FIG. 24 is a flowchart showing a user setting information acquisition processing according to the fourth exemplary embodiment.

FIG. 25 is a flowchart showing an another person's user setting information acquisition processing according to the fourth exemplary embodiment.

FIG. 26 is a flowchart showing a user setting information acquisition processing based on the statistical data according to the fourth exemplary embodiment.

FIG. 27 is a block diagram schematically showing an arrangement of a content output system according to the fifth exemplary embodiment.

FIG. 28 is a block diagram schematically showing an arrangement of a display according to the fifth exemplary embodiment.

FIG. 29 schematically shows an arrangement of a user database according to the fifth exemplary embodiment.

FIG. 30 is a flowchart showing an another person's user setting information acquisition processing according to the fifth exemplary embodiment.

### EXPLANATION OF CODES

1A,1B,1C,1D,1E . . . content output system
2A,2C,2D,2E . . . display serving as output device
3A,3B,3C,3D . . . server serving as content set value information acquiring device
120 . . . display unit included in output unit
130 . . . sound output unit included in output unit
172,472,672,882 . . . parameter request information acquirer serving as request information transmitter
173 . . . correction setting unit serving as user set value information transmitter
174,886 . . . image-sound controller serving as output mode controller
220,320,870 . . . image-quality and sound-quality database serving as output mode registration information storage
221A,321A,521A,722A,871A . . . user parameter registration information serving as output mode registration information
230,330,530,730 . . . server processor serving as computer
231,331,883 . . . user setting information acquirer serving as user's information acquiring processor and another person's information acquiring processor that also serve as request information acquirer, content set value information generator and content set value information transmitter
232,332,533,733 . . . database updater serving as updating unit
520,720 . . . image-quality and sound-quality database serving as output mode registration information storage, output conversion information storage, and registration conversion information storage
522A . . . output conversion information
523A . . . registration conversion information
531,731 . . . user setting information acquirer serving as user's information acquiring processor and another person's information acquiring processor that also serve as request information acquirer
532 . . . device conversion processor serving as content set value information generator and content set value information transmitter
880 . . . automatic setting unit serving as content set value information acquiring device and computer
N . . . network

### BEST MODE FOR CARRYING OUT THE INVENTION

### First Exemplary Embodiment

A first exemplary embodiment of the invention will be described with reference to the attached drawings.

In the first exemplary embodiment, a content output system including a content set value information acquiring device for adjusting image quality as an output mode and sound quality as an output mode in accordance with user's preference that changes depending on contents will be exemplarily described. Specifically, an arrangement for adjusting a contrast of an image and an output level of sound will be exemplarily described.

The image(s) is either a still image(s) or a motion image(s). Also, frequency characteristics, sound quality level, sound delay or the like may be adjusted instead of the output level of sound.

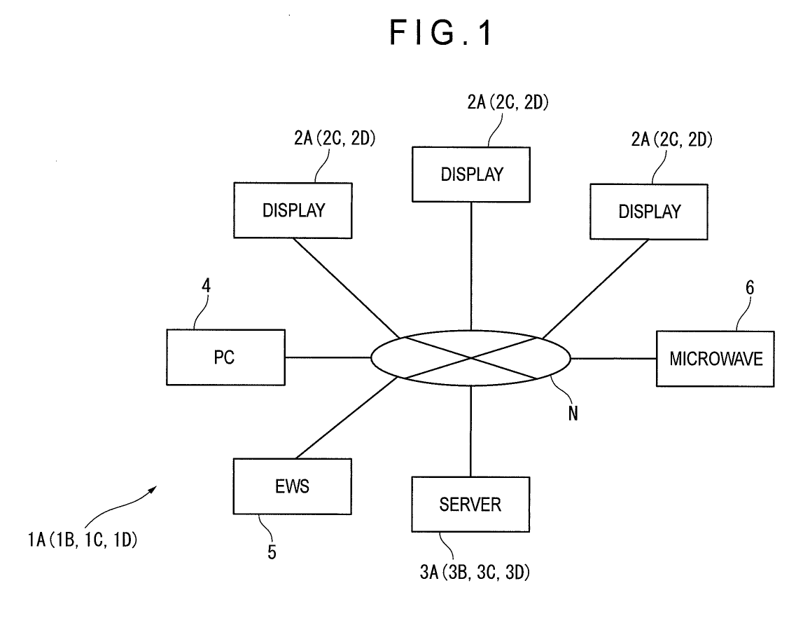

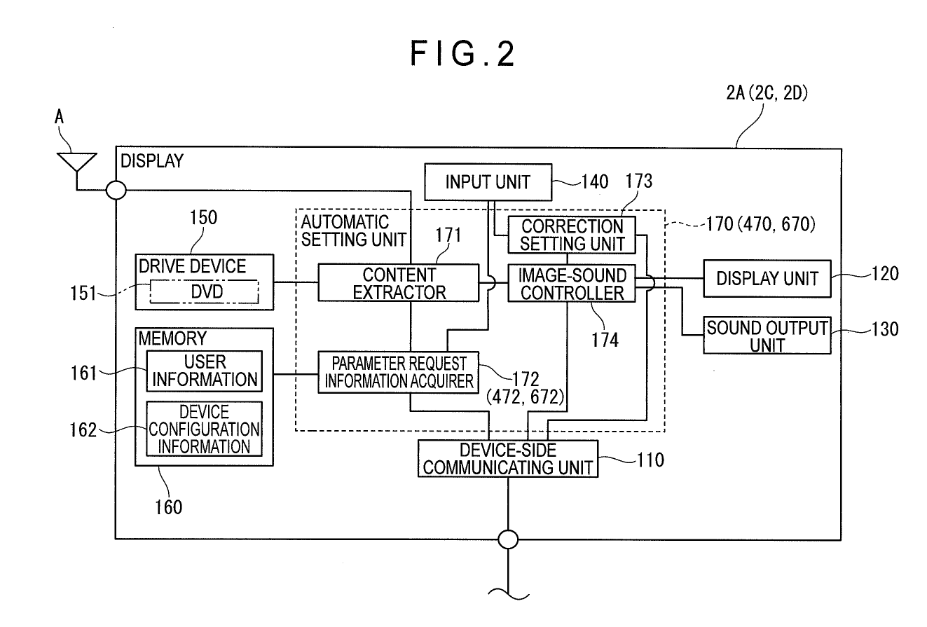

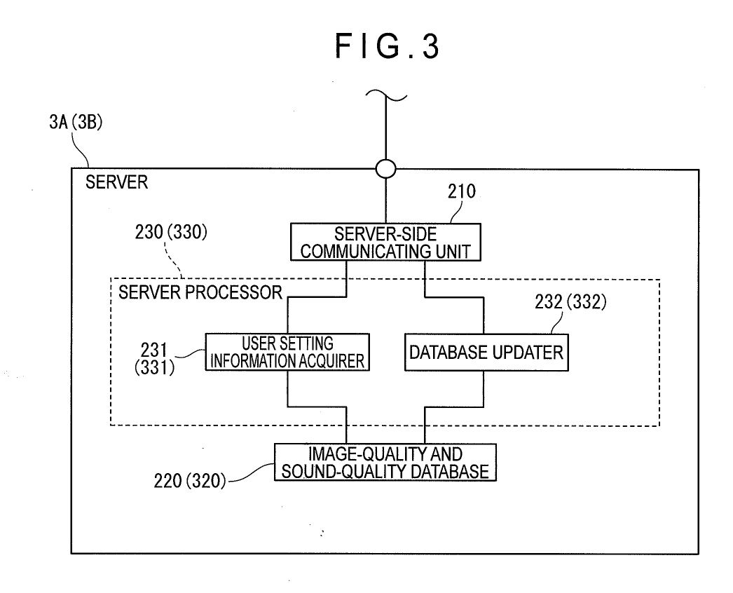

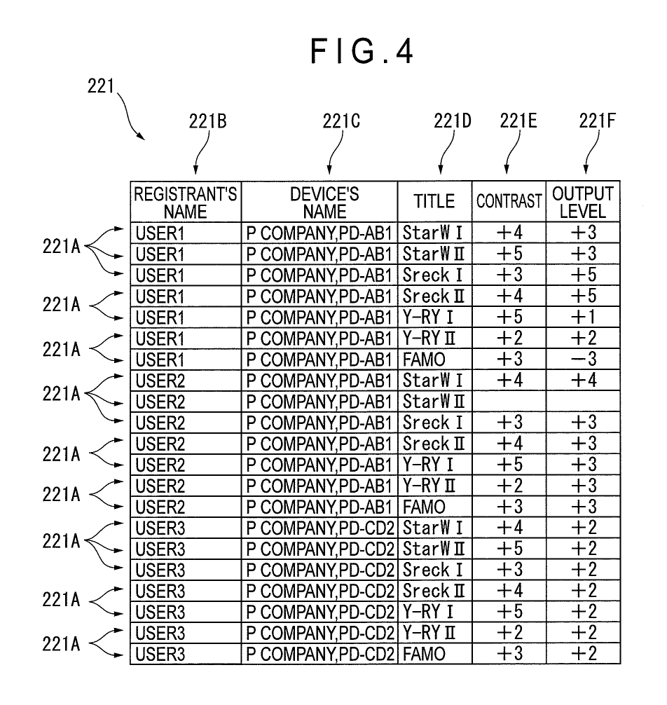

FIG. 1 is a block diagram schematically showing an arrangement of the content output system. FIG. 2 is a block diagram schematically showing an arrangement of a display. FIG. 3 is a block diagram schematically showing an arrangement of a server. FIG. 4 schematically shows an arrangement of a user database.

### [Arrangement of Content Output System]

In FIG. 1, 1A denotes the content output system.

The content output system 1A includes: a network N; at least one display 2A serving as an output device; a server 3A serving as a content set value information acquiring device; a PC (personal computer) 4; an EWS (engineering work station) 5; and a microwave 6.

The display 2A, server 3A, PC 4, EWS 5 and microwave 6 are connected to the network N. Examples of the network N include: the Internet; intranet; LAN (local area network); a network such as a communication line network and a broadcasting network in which a plurality of base stations capable of sending and receiving information via wireless media form a network; and wired or wireless media that form media for directly sending and receiving information among the display 2A, server 3A, PC 4, EWS 5 and microwave 6.

As shown in FIG. 2, the display 2A includes: a device-side communicating unit 110; a display unit 120 included in an output unit; a sound output unit 130 included in the output unit; an input unit 140; a drive device 150; a memory 160; and an automatic setting unit 170.

The device-side communicating unit 110 is connected to the network N for transmitting and receiving various information to and from the server 3A.

Specifically, the device-side communicating unit 110 receives information from the server 3A to suitably transmit the information to the automatic setting unit 170, and receives information from the automatic setting unit 170 to suitably transmit the information to the server 3A.

The display unit 120 is connected to the automatic setting unit 170.

The display unit 120 is controlled by the automatic setting unit 170 to display a quality-adjusted image on a screen based on a quality-adjusted image data transmitted from the automatic setting unit 170. Examples of the display unit 120 include a liquid crystal panel, an organic EL (electro luminescence) panel, a PDP (plasma display panel), a CRT (cathode-ray tube), an FED (field emission display) and an electrophoretic display panel.

The sound output unit 130 has a speaker (not shown). The sound output unit 130 is connected to the automatic setting unit 170.

The sound output unit 130 is controlled by the automatic setting unit 170 to output quality-adjusted sound from the speaker based on a quality-adjusted sound data transmitted from the automatic setting unit 170.

The input unit 140 is connected to the automatic setting unit 170. The input unit 140 has various operation buttons and operation knobs (not shown).

When settings of, for instance, operation contents of the display 2A, are input, the input unit 140 outputs various information to the automatic setting unit 170 so as to apply the settings.

The input unit 140 may employ any input operation capable of inputting various settings such as an input operation using a touch panel provided on the display unit 120, an input operation with a voice and an input operation via a remote controller.

The drive device 150 is connected to the automatic setting unit 170, and a DVD 151 is detachably provided to the drive device 150.

The drive device 150 is controlled by the automatic setting unit 170 to read content data including image data and sound data recorded on the DVD 151 and output the content data to the automatic setting unit 170. The drive device 150 also reads TOC (table of contents) data relating to contents recorded on the DVD 151 and outputs the TOC data to the automatic setting unit 170.

The memory 160 is connected to the automatic setting unit 170.

The memory 160 readably stores a user information 161 relating to a name that is information specific to a user of the display 2A and a device configuration information 162 relating to a manufacturer and type of the display 2A.

The automatic setting unit 170 includes: a content extractor 171; a parameter request information acquirer 172 serving as a request information transmitter; a correction setting unit 173 serving as a user set-input value information transmitter; and an image-sound controller 174 serving as an output mode controller, all of which are installed as a program.

The content extractor 171 is connected to the drive device 150, the parameter request information acquirer 172, the image-sound controller 174 and the like.

The content extractor 171 acquires the content data and TOC data read by the drive device 150. Then, the content extractor 171 extracts the content data to output the extracted content data to the image-sound controller 174 and output the TOC data to the parameter request information acquirer 172.

The content extractor 171 is connected to an antenna A for receiving airwaves.

The content extractor 171 acquires content data, metadata, EPG (electric program guide) data and the like via airwaves received using the antenna A. Then, the content extractor 171 extracts the content data to output the content data to the image-sound controller 174 and output the metadata and EPG data relating to contents to the parameter request information acquirer 172.

The parameter request information acquirer 172 is connected to the device-side communicating unit 110, the input unit 140, the memory 160 and the like.

When the content extractor 171 extracts content data transmitted from the DVD 151, the parameter request information acquirer 172 acquires TOC data as a content information from the content extractor 171. When the content extractor 171 extracts content data transmitted via airwave, the parameter request information acquirer 172 acquires metadata and EPG data as a content information from the content extractor 171. Further, the parameter request information acquirer 172 acquires the user information 161 and the device configuration information 162 from the memory 160. Then, the parameter request information acquirer 172 controls the device-side communicating unit 110 to transmit to the server 3A via the network N the content information, the user information 161 and the device configuration information 162 as a parameter request information serving as a request information.

The correction setting unit 173 is connected to the device-side communicating unit 110, the input unit 140, the image-sound controller 174 and the like.

The correction setting unit 173 recognizes a contrast set value and a sound-output-level set value that are corrected and set by a user based on an input operation by the input unit 140.

The contrast set value and the sound-output-level set value that are corrected and set will be hereinafter collectively referred to as a corrected image-quality and sound-quality parameter serving as the user set-input value information.

Then, the corrected image-quality and sound-quality parameter is outputted to the image-sound controller 174. When recognizing to register the corrected image-quality and sound-quality parameter in the server 3A, the correction setting unit 173 controls the device-side communicating unit 110 to transmit the corrected image-quality and sound-quality parameter to the server 3A via the network N. Further, the correction setting unit 173 controls the parameter request information acquirer 172 to transmit the parameter request information to the server 3A.

The image-sound controller 174 is connected to the device-side communicating unit 110, the display unit 120, the sound output unit 130 and the like.

The image-sound controller 174 acquires content data from the content extractor 171. Further, the image-sound controller 174 acquires an image-quality and sound-quality optimum parameter serving as a content set value information transmitted from the server 3A corresponding to the parameter request information via the network N and the device-side communicating unit 110. The image-quality and sound-quality optimum parameter includes a contrast set value for reproducing a contrast corresponding to user's preference, and a sound-output-level set value for reproducing an output level of sound.

The image-sound controller 174 generates quality-adjusted image data by adjusting image data based on the contrast set value, and controls the display unit 120 to display on a screen the quality-adjusted image in which a contrast is adjusted. Further, the image-sound controller 174 generates quality-adjusted sound data by adjusting sound data based on the sound-output-level set value, and controls the display unit 130 to output the quality-adjusted sound in which an output level of sound is adjusted.

Furthermore, the image-sound controller 174 suitably acquires the corrected image-quality and sound-quality parameter from the correction setting unit 173, and performs a display control of the quality-adjusted image and an output control of the quality-adjusted sound. Here, the quality-adjusted image and the quality-adjusted sound are corrected and set based on the acquired parameter.

As shown in FIG. 3, the server 3A includes: a server-side communicating unit 210; an image-quality and sound-quality database 220 serving as an output mode registration information storage; and a server processor 230 serving as a computer.

The server-side communicating unit 210 is connected to the network N for sending and receiving various information to and from the display 2A.

Specifically, the server-side communicating unit 210 receives information transmitted from the display 2A to suitably output the information to the server processor 230, and receives information from the server processor 230 to suitably output the information to the display 2A.

The image-quality and sound-quality database 220 stores a user database 221 as shown in FIG. 4.

The user database 221 is suitably updated by the server processor 230.

The user database 221 includes at least one user parameter registration information 221A serving as an output mode registration information that includes an information relating to image-quality and sound-quality of user's preference that are set for every content by a user of each display 2A.

The user parameter registration information 221A includes a registrant's name information 221B, an user device's name information 221C, a request content information 221D, an image-quality set value information 221E and a sound-quality set value information 221F.

The registrant's name information 221B is for identifying a user.

The user device's name information 221C is for identifying a manufacturer and type of the display 2A used by the user.

The request content information 221D indicates a title of a content as an information for identifying the content identified by the content information from the user.

The image-quality set value information 221E indicates a contrast set value as a set value of image-quality set by the display 2A.

The sound-quality set value information 221F indicates a sound output-level set value as a set value of sound-quality set by the display 2A.

In short, the user parameter registration information 221A includes informations relating to the content, the display 2A, the image-quality and sound-quality optimum parameter regarding the output mode and the like.

Though the image-quality set value information 221E as shown in FIG. 4 exemplarily includes only contrast set value, the image-quality set value information 221E usually includes a set value relating to plural image qualities such as contrast, brightness, color and sharpness. When the set value relating to plural image qualities is included, image settings more suited to user's preference can be inputted. In addition, when a later-described user setting information of another person who has similar preference to a user is acquired, accuracy can be enhanced. Incidentally, the sound-quality set value information 221F also usually includes a set value relating to plural sound qualities.

As shown in FIG. 3, the server processor 230 includes: a user setting information acquirer 231 serving as a user's information acquiring processor and an another person's information acquiring processor that also serve as a request information acquirer, a content set value information generator and a content set value information transmitter; and a database updater 232 serving as an updating unit, both of which are installed as a program.

The user setting information acquirer 231 is connected to the server-side communicating unit 210, the image-quality and sound-quality database 220 and the like.

The user setting information acquirer 231 acquires an image-quality and sound-quality optimum parameter corresponding to a predetermined user and a content viewed by the user as the user setting information.

Specifically, the user setting information acquirer 231 acquires the content information, the user information 161 and the device configuration information 162 of the parameter request information transmitted from a predetermined display 2A via the server-side communicating unit 210. When the content information is given as TOC data, the TOC data is converted into a content-related information relating to a content such as a genre, series, title, chapter and scene. When the content information is given as metadata or EPG data, the content-related information is recognized based on the metadata or EPG data. The content specified by the content-related information will be hereinafter referred to as a request content.

The user setting information acquirer 231 acquires a user setting information of a user of the display 2A that has transmitted the parameter request information.

In other words, the user setting information acquirer 231 retrieves the user parameter registration information 221A that includes the user's name of the user information 161 and the title of the request content (i.e., the user parameter registration information 221A including the user's name and relating to the request content). When the retrieved user parameter registration information 221A includes an image-quality and sound-quality optimum parameter, the user setting information acquirer 231 acquires the image-quality and sound-quality optimum parameter as the user's user setting information.

When the user setting information acquirer 231 cannot acquire the user setting information of the user, the user setting information acquirer 231 acquires a user setting information of another person having similar preference to the user.

In short, the user setting information acquirer 231 retrieves the user parameter registration information 221A including an another person's user name, a content of the device configuration information 162 and a title of the request content. When the retrieved user parameter registration information 221A includes an image-quality and sound-quality optimum parameter, the user setting information acquirer 231 determines whether an image-quality and sound-quality optimum parameter relating to contents other than the request content (hereinafter referred to as other contents) corresponds to an image-quality and sound-quality optimum parameter relating to the other contents of a user requesting the image-quality and sound-quality optimum parameter. In other words, the user setting information acquirer 231 determines whether an information relating to the content does not correspond to a content of the parameter request information and whether image-quality and sound-quality optimum parameters associated with the user and another person correspond to each other. When such parameters are coincident, the user setting information acquirer 231 acquires an image-quality and sound-quality optimum parameter of the another person relating to the request content as the another person's setting information.

Incidentally, in order to determine coincidence of the image-quality and sound-quality parameters relating to the other contents, whether all informations relating to the other contents are coincident may be determined. Alternatively, the coincidence may be determined based on the number of coincident informations.

When the user setting information acquirer 231 cannot acquire the user's user setting information or the another person's user setting information, the user setting information acquirer 231 acquires a default value set in advance as the user setting information.

Then, an image-quality and sound-quality optimum parameter of the acquired user setting information is transmitted to the display 2A corresponding to the parameter request information via the network N.

Incidentally, the user setting information acquirer 231 may have an arrangement to perform processing as described below.

When the user setting information acquirer 231 cannot acquire the user's user setting information, plural user parameter registration informations 221A of other persons may be displayed and then a user may select one of the user parameter registration informations 221A.

Here, settings of the user parameter registration informations 221A of the other persons include settings selected by a specific group or organization such as settings popular in Japan and settings popular in America. The user parameter registration informations 221A of the other persons can be registered according to genres, series, or titles.

When the content is a movie, the user parameter registration informations 221A of the other persons can be registered according to movie directors or movie producers. Further, when the content is a movie, settings of a movie director may be registered as the user parameter registration informations 221A of the other persons.

With such an arrangement, settings of a specific group or organization except for general viewers can be acquired as the another person's user setting information.

Alternatively, the user setting information acquirer 231 may select the another person's user setting information of a person having similar preference to a user as described below.

For instance, four components of A, B, C and D (for instance, contrast, brightness, color and sharpness) are defined as parameters of the image-quality set value information 221E. When levels for each component are represented by eleven numerical numbers such as −5, −4, . . . , 4 and 5, the user setting information acquirer 231 determines a difference for every parameter in the image-quality set value informations 221E of a user and another person relating to the same genre and different titles, calculates an absolute value of the difference, and determines that user's preference is similar to another person's preference when the calculated absolute value is a predetermined value or less. Alternatively, the user setting information acquirer 231 may calculate a correlation, and determine that the user and another person have similar preference when the correlation is a predetermined value or less.

The database updater 232 is connected to the server-side communicating unit 210, the image-quality and sound-quality database 220 and the like.

The database updater 232 updates the user parameter registration information 221A of a predetermined user.

Specifically, the database updater 232 acquires the corrected image-quality and sound-quality parameter and parameter request information transmitted from the display 2A via the server-side communicating unit 210. Further, the database updater 232 retrieves the user parameter registration information 221A including the user name of the user information 161 and the title of the request content. Then, the image-quality and sound-quality optimum parameter of the retrieved user parameter registration information 221A is updated to the corrected image-quality and sound-quality parameter.

### [Operation of Content Output System]

Next, an operation of the content output system 1A will be described.

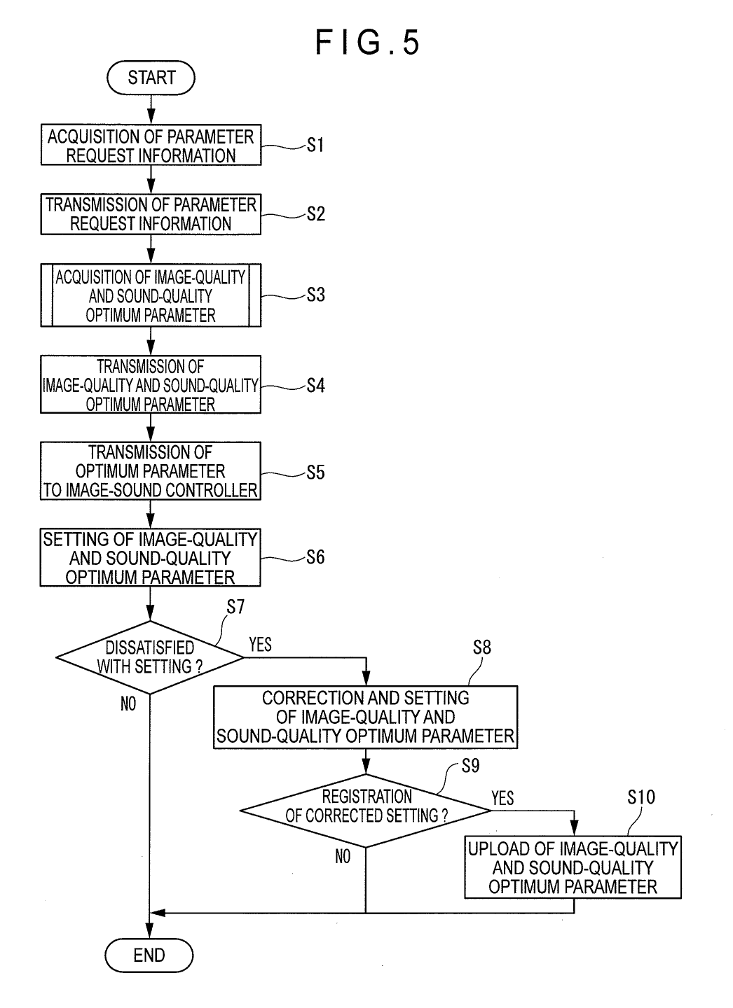

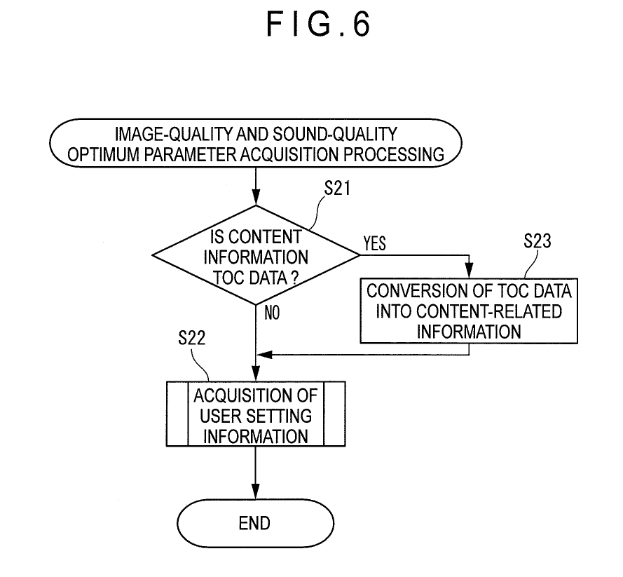

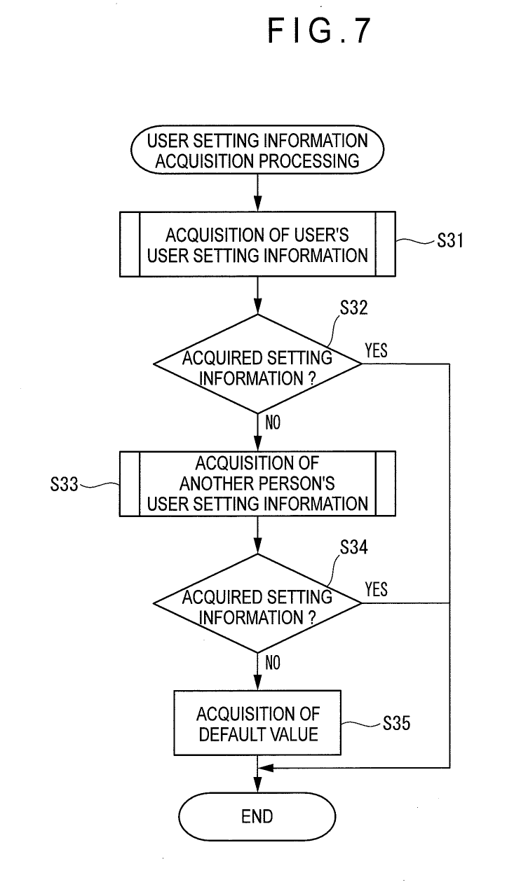

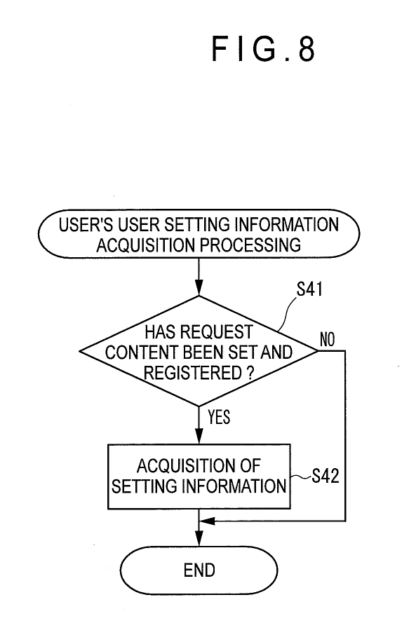

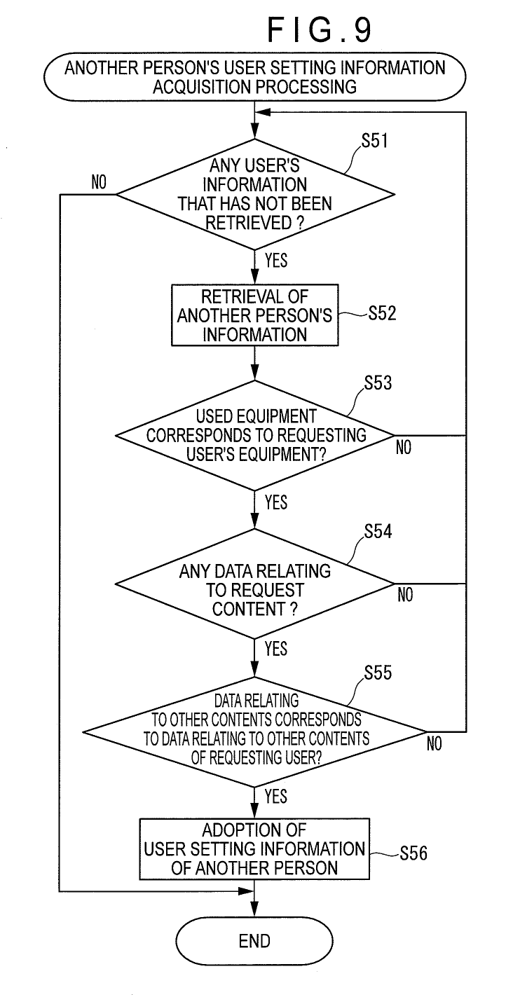

FIG. 5 is a flow chart showing an image-quality and sound-quality adjustment processing. FIG. 6 is a flow chart showing an image-quality and sound-quality optimum parameter acquisition processing. FIG. 7 is a flowchart showing a user setting information acquisition processing. FIG. 8 is a flowchart showing a user's user setting information acquisition processing. FIG. 9 is a flowchart showing an another person's user setting information acquisition processing.

The display 2A of the content output system 1A acquires the parameter request information when outputting a content read from the DVD 151 or received via airwaves (step S1), and transmits the parameter request information to the server 3A via the network N (step S2).

When the server 3A receives the parameter request information, the server 3A acquires the image-quality and sound-quality optimum parameter (step S3) and transmits the optimum parameter to the display 2A corresponding to the parameter request information via the network N (step S4).

The display 2A receives the image-quality and sound-quality optimum parameter transmitted corresponding to the parameter request information and transmits the acquired optimum parameter to the image-sound controller 174 (step S5). Then, the image-sound controller 174 sets the image-quality and sound-quality optimum parameter (step S6) to output a content of which image-quality and sound-quality are suitably adjusted in accordance with the request content and user's preference.

Subsequently, the display 2A determines whether or not a user is dissatisfied with the setting of the image-quality and sound-quality optimum parameter (step S7). When the display 2A determines that the user is not dissatisfied in the step S7, the processing is terminated. On the other hand, when the display 2A determines that the user is dissatisfied in the step S7, the display 2A sets the corrected image-quality and sound-quality parameter based on the settings input by the user (step S8) to output a content of which image-quality and sound-quality are suitably adjusted.

Further, the display 2A determines whether or not to register the setting in the server 3A (step S9). When the display 2A determines not to register the setting in the step S9, the processing is terminated. On the other hand, when the display 2A determines to register the setting, the corrected image-quality and sound-quality parameter is uploaded to the server 3A (step S10). In other words, the server 3A updates the user parameter registration information 221A corresponding to the user and request content based on the corrected image-quality and sound-quality parameter and parameter request information transmitted from the display 2A.

In the acquisition processing of the image-quality and sound-quality optimum parameter in the step S3, the server 3A determines whether or not the content information of the parameter request information is TOC data as shown in FIG. 6 (step S21). When determining that the content information is not the TOC data in the step S21, the server 3A acquires the user setting information (step S22) and then ends the processing. When determining that the content information is the TOC data in the step S21, the server 3A converts the TOC data into the content-related information (step S23) and then performs the processing of the step S22.

In the acquisition processing of the user setting information in the step S22, the server 3A performs the acquisition processing of the user setting information of a user of the display 2A, i.e., the user's user setting information, as shown in FIG. 7 (step S31), and determines whether or not the server 3A acquires the user setting information (step S32). When determining that the server 3A has been able to acquire the person's user setting information in the step S32, the processing is terminated. On the contrary, when determining that the server 3A has been unable to acquire the person's user setting information in the step S32, the server 3A performs the acquisition processing of the another person's user setting information (step S33), and then determines whether or not the server 3A has been able to acquire the another person's user setting information (step S34).

When determining that the server 3A has been able to acquire the another person's user setting information in the step S34, the processing is terminated. On the contrary, when determining that the server 3A has been unable to acquire the another person's user setting information in the step S34, the server 3A acquires a default value as the user setting information (step S35) and ends the processing.

Further, in the acquisition processing of the user's user setting information in the step S31, the server 3A determines whether or not the request content has been set and registered in the past as shown in FIG. 8 (step S41). In other words, the server 3A determines whether or not the user parameter registration information 221A corresponding to the user and request content includes the image-quality and sound-quality optimum parameter.

When determining that the request content has not been set or registered, the server 3A does not acquire the user's user setting information and ends the processing. On the contrary, when determining that the request content has been set and registered, the server 3A acquires the image-quality and sound-quality optimum parameter of the user parameter registration information 221A as the user's user setting information (step S42) and ends the processing.

Further, in the acquisition processing of the another person's user setting information in the step S33, the server 3A determines whether the user parameter registration information 221A of a user that has not been retrieved exists (step S51) as shown in FIG. 9. When determining that the server 3A has retrieved the user parameter registration information 221A of all users in the step S51, the server 3A does not acquire the another person's user setting information and ends the processing. On the contrary, when determining that the server 3A has not retrieved the user parameter registration information 221A of all users in the step S51, the server 3A retrieves the another person's user parameter registration information 221A (step S52) and determines whether a device (display 2A) used by another person corresponds to a device used by a user requesting the image-quality and sound-quality optimum parameter (step S53).

When determining such devices are not coincident in the step S53, the processing is returned to the step S51. On the other hand, when determining such devices are coincident, the server 3A determines whether data relating to the request content (image-quality and sound-quality optimum parameter) exists (step S54).

When the server 3A determines that such data relating to the request content does not exist in the step S54, the processing is returned to the step S51. On the contrary, when determining that such data relating to the request content exists in the step S54, the server 3A determines whether data relating to the other contents corresponds to data relating to the other contents for the user requesting the image-quality and sound-quality optimum parameter (step S55). When determining that such data are coincident in the step S55, the server 3A acquires the image-quality and sound-quality optimum parameter of the person as the another person's user setting information. On the contrary, when the server 3A determines that such data are not coincident in the step S55, the processing is returned to the step S51.

### [Advantages of First Exemplary Embodiment]

As described above, according to the first exemplary embodiment, the server 3A of the content output system 1A acquires the user parameter registration information 221A including the user's name of the display 2A and the title of the request content based on the parameter request information transmitted from the display 2A. When the user parameter registration information 221A includes the image-quality and sound-quality optimum parameter, the server 3A acquires the image-quality and sound-quality optimum parameter as the user's user setting information. When the server 3A has been unable to acquire the user's user setting information, the server 3A retrieves the user parameter registration information 221A including the user's name of another person and the title of the request content. When the retrieved user parameter registration information 221A includes the image-quality and sound-quality optimum parameter, the server 3A determines whether the image-quality and sound-quality optimum parameter relating to the other contents corresponds to the image-quality and sound-quality optimum parameter relating to the other contents of the user requesting the image-quality and sound-quality optimum parameter. When such parameters are coincident, the server 3A acquires the image-quality and sound-quality optimum parameter of another person relating to the request content as the another person's user setting information. Then, the user's user setting information or another person's user setting information is transmitted to the display 2A.

When the display 2A receives the user setting information, the display 2A controls the display unit 120 to display a quality-adjusted image of which a contrast is adjusted and controls the sound output unit 130 to output a quality-adjusted sound of which a output level is adjusted based on the image-quality and sound-quality optimum parameter.

Accordingly, in the content output system 1A, the display 2A can output a request content of which image-quality and sound-quality are adjusted to meet user's preference based on the image-quality and sound-quality optimum parameter of the user acquired by the server 3A. Even when the image-quality and sound-quality optimum parameter of a user does not exist in the server 3A such as when a new content is viewed, the user can view the request content adjusted to meet user's preference without setting the image-quality and sound-quality optimum parameter by himself by outputting the request content based on the image-quality and sound-quality optimum parameter of the request content set by another person having similar preference (i.e., the image-quality and sound-quality optimum parameters relating to the other contents are substantially coincident).

Thus, a content of an output mode that meets user's preference can be outputted without complicated operation.

When the server 3A cannot acquire the user setting information of the user or another person, the server 3A transmits to the display 2A a default value set in advance as the user setting information.

Accordingly, the display 2A can prevent problems in acquiring the user setting information and provide comfortable space for viewing.

Also, an image of quality corresponding to the user's preference can be displayed and a sound of quality corresponding to the user's preference can be outputted.

Thus, a user can more enjoyably view shows or movies that are transmitted via airwaves or recorded on the DVD 151.

Then, when acquiring the another person's user setting information, the display 2A acquires the information set by another person who uses the display 2A of which the manufacturer and type are the same as one used by the user.

When acquiring the another person's user setting information of another person who uses the display 2A of which the type is different from one used by the user, adjustment states may be different in setting the same image-quality and sound-quality optimum parameters in the displays 2A used by the user and another person.

Thus, when the another person's user setting information is acquired, the possibility that the request content that is not adjusted to meet user's preference is viewed can be reduced.

Also, the server 3A includes the image-quality and sound-quality database 220, and transmits the image-quality and sound-quality optimum parameter to each display 2A based on the user parameter registration information 221A of the image-quality and sound-quality database 220.

Accordingly, the display 2A can acquire the image-quality and sound-quality optimum parameter only by transmitting the parameter request information once to the server 3A. Thus, the request content adjusted in accordance with the user's preference can be outputted more quickly.

Further, the user parameter registration information 221A of the user database 221 is suitably updated with the corrected image-quality and sound-quality parameter that is corrected and set by the user.

Thus, even when the user changes his preference, an image-quality and sound-quality optimum parameter that appropriately meets user's preference can be newly stored in the server 3A, thereby enhancing user-friendliness.

The server 3A can identify the request content based on the metadata or EPG data transmitted via airwaves.

Thus, broadcast programs commonly viewed can be adjusted to meet the user's preference, which easily contributes to promotion of utilization.

Further, the server 3A can specify the request content based on the TOC data recorded on the DVD 151.

Thus, even recorded programs can be adjusted to meet the user's preference, which contributes to promotion of utilization more easily.

### Second Exemplary Embodiment

Next, a second exemplary embodiment of the invention will be described below with reference to the attached drawings.

In the second exemplary embodiment, a content output system including a content set value information acquiring device for adjusting image-quality in accordance with user's preference that changes depending on genres, series, titles, chapters and scenes of a content will be exemplarily described. Alternatively, the content outputs system may adjust sound-quality in accordance with a genre, series, title and chapter.

Incidentally, the components same as those in the first exemplary embodiment will be denoted by the same numerals and names, and the description thereof will be omitted or simplified.

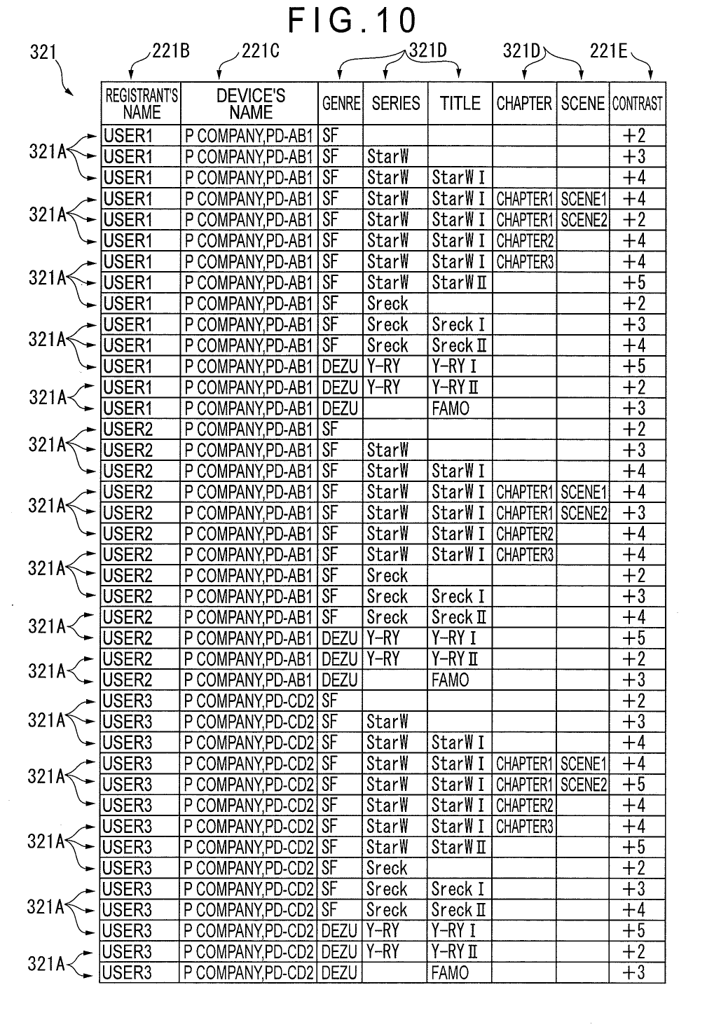

FIG. 10 schematically shows an arrangement of a user database.

### [Arrangement of Content Output System]

As shown in FIG. 1, 1B denotes the content output system. The content output system 1B includes: a network N; at least one display 2A; a server 3B serving as a content set value information acquiring device; a PC 4; an EWS 5; and a microwave 6.

As shown in FIG. 3, the server 3B includes: a server-side communicating unit 210; an image-quality and sound-quality database 320 serving as an output mode registration information storage; and a server processor 330 serving as a computer.

The image-quality and sound-quality database 320 stores at least one user database 321 as shown in FIG. 10.

The user database 321 is suitably updated by the server processor 330.

The user database 321 includes at least one user parameter registration information 321A serving as an output mode registration information.

The user parameter registration information 321A includes: a registrant's name information 221B; a user device's name information 221C; a request content information 321D; and an image-quality set value information 221E.

The request content information 321D is for identifying at least a genre of the content. The request content information 321D suitably includes an information for identifying a series that is lower than the genre, a title that is lower than the series, a chapter that is lower than the title and a scene that is lower than the chapter in a hierarchic structure of categories of a content.

As shown in FIG. 3, the server processor 330 includes: a user setting information acquirer 331 serving as a user's information acquiring processor and an another person's information acquiring processor that also serve as a request information acquirer, a content set value information generator and a content preset information transmitter; and a database updater 332 serving as an updating unit, both of which are installed as a program.

The user setting information acquirer 331 acquires an image-quality and sound-quality optimum parameter corresponding to a predetermined user and a content viewed by the user as a user setting information.

Specifically, the user setting information acquirer 331 acquires the content information, the user information 161 and the device configuration information 162 of the parameter request information. Further, the user setting information acquirer 331 recognizes a content-related information of a request content based on the content information.

The user setting information acquirer 331 acquires a user setting information of a user of the display 2A that has transmitted the parameter request information.

In short, the user setting information acquirer 331 retrieves the user parameter registration information 321A relating to the lowest category of the request content corresponding to the user information 161. Then, the user setting information acquirer 331 acquires the image-quality and sound-quality optimum parameter of the retrieved user parameter registration information 321A as the user's user setting information.

For example, when the genre, series, title, chapter and scene of the request content of “user 1” are “SF”, “StarW”, “StarW1”, “chapter 1” and “scene 1”, the image-quality set value of “+4” is acquired as the user's user setting information.

Further, when the user parameter registration information 321A relating to the lowest category does not include the image-quality and sound-quality optimum parameter, the user setting information acquirer 331 acquires the image-quality and sound-quality optimum parameter of the user parameter registration information 321A relating to the immediate upper category as the user's user setting information.

For example, when the genre, series, title, chapter and scene of the request content of “user 1” are “SF”, “StarW”, “StarW1”, “chapter 2” and “scene 1”, the user setting information acquirer 331 acquires the image-quality setting value of “+4” corresponding to the “SF”, “StarW”, “StarW1” and “chapter 2” in the second lowest category as the user's user setting information.

When the user setting information acquirer 331 cannot acquire the user's user setting information, the user setting information acquirer 331 suitably acquires an image-quality and sound-quality optimum parameter corresponding to a further upper category.

Further, when the user parameter registration information 321A relating to the uppermost category does not include the image-quality and sound-quality optimum parameter, the user setting information acquirer 331 determines that the user setting information acquirer 331 cannot acquire the user's user setting information. Then, the user setting information acquirer 331 acquires the another person's user setting information of another person who has similar preference to the user.

In other words, the user setting information acquirer 331 acquires the image-quality and sound-quality optimum parameter relating to the lowest category of the request content as the another person's user setting information from the user parameter registration information 321A of another person of which the image-quality and sound-quality optimum parameter for the other contents is coincident with that of the user.

When the user setting information acquirer 331 cannot acquire the user's user setting information and the another person's user setting information, the user setting information acquirer 331 acquires a default value as the user setting information.

The database updater 332 updates the user parameter registration information 321A of a predetermined user.

Specifically, the database updater 332 acquires the corrected image-quality and sound-quality parameter and parameter request information transmitted from a predetermined display 2A, and retrieves the user parameter registration information 321A corresponding to the user information 161 and relating to the lowest category of the request content. Then, the database updater 332 updates the image-quality and sound-quality optimum parameter of the user parameter registration information 321A with the corrected image-quality and sound-quality parameter.

### [Operation of Content Output System]

Next, an operation of the content output system 1B will be described.

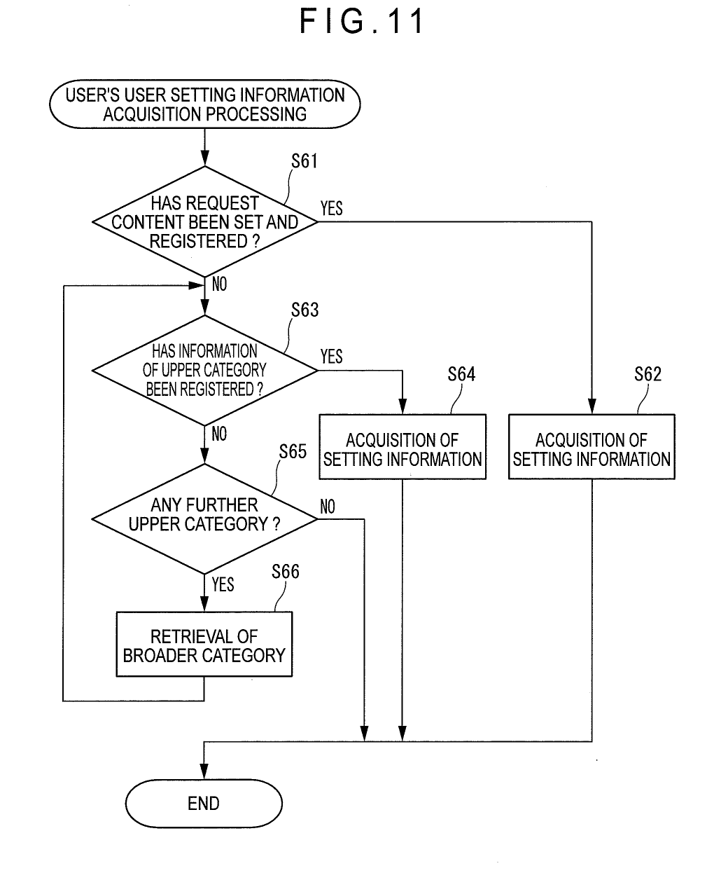

FIG. 11 is a flowchart showing a user's user setting information acquisition processing.

Processing(s) except for the user's user setting information acquisition processing is the same as that of the first exemplary embodiment, and the description thereof will be simplified.

The content output system 1B performs: the image-quality and sound-quality adjustment processing as shown in FIG. 5; the image-quality and sound-quality optimum parameter acquisition processing as shown in FIG. 6; the user setting information acquisition processing as shown in FIG. 7; and the another person's user setting information acquisition processing as shown in FIG. 9.

In the acquisition processing of the user's user setting information acquisition processing of the user setting information acquisition processing in the step S31, the server 3B determines whether or not the lowest category of the request content has been set and registered in the past as shown in FIG. 11 (step S61). When determining that the lowest category has been set and registered in the step S61, the server 3A acquires the set and registered image-quality and sound-quality optimum parameter as the user's user setting information (step S62) and ends the processing. On the contrary, when determining that the lowest category has not been set or registered in the step S61, the server 3A determines whether or not an upper category has been set and registered in the past (step S63).

When determining that the upper category has been set and registered in the step S63, the server 3A acquires the set and registered image-quality and sound-quality optimum parameter as the user's user setting information (step S64) and ends the processing. When determining that the upper category has not been set or registered in the step S63, the server 3A determines whether or not a further upper category of the request content exists (step S65).

When determining that the further upper category does not exist in the step S65, the server 3A ends the processing without acquiring the another person's user setting information. On the contrary, when determining that the further upper category exists in the step S65, the server 3A retrieves the further upper category (step S66) and then the processing is returned to the step S63.

### [Advantages of Second Exemplary Embodiment]

In the second exemplary embodiment as described above, the following advantages can be obtained in addition to the advantages of the first exemplary embodiment.

The user parameter registration information 321A includes information for identifying a genre, series, title, chapter and scene that hierarchically indicate categories of a content. Then, when the user parameter registration information 321A relating to the lowest category does not include the image-quality and sound-quality optimum parameter, the image-quality and sound-quality optimum parameter of the user parameter registration information 321A relating to an upper category is acquired.

Accordingly, even when the image-quality and sound-quality optimum parameter of the request content is not registered in advance, the image-quality and sound-quality optimum parameter is acquired from the user parameter registration information 321A relating to the user. Thus, the image-quality and sound-quality optimum parameter can be acquired more quickly as compared to an arrangement for acquiring the image-quality and sound-quality optimum parameter of another person. Hence, the request content adjusted to meet user's preference can be outputted more quickly.

When the user parameter registration information 321A relating to the lowest category does not include the image-quality and sound-quality optimum parameter, the image-quality and sound-quality optimum parameter of the user parameter registration information 321A relating to an upper category is acquired. When such optimum parameter relating to the upper category cannot be acquired, the image-quality and sound-quality optimum parameter relating to a further upper category is acquired. In other words, among the user parameter registration informations 321A that exhibit coincidence with the parameter request information in the categories other than the lowermost category, the user parameter registration information 321A that exhibits the coincidence with the parameter request information at the most subordinated category is selected and the image-quality and sound-quality optimum parameter thereof is acquired.

Accordingly, when there is no user parameter registration information that exhibits the coincidence with the parameter request information in the “scene” category and thus no image-quality and sound-quality optimum parameter is acquired, the image-quality and sound-quality optimum parameter can be acquired from the user parameter registration information that exhibits coincidence with the parameter request information in the “chapter” category but relates to another scene. Thus, as compared to an arrangement in which an image-quality and sound-quality optimum parameter that exhibits the coincidence with the parameter request information in the “genre” category but relates to another series is acquired even though there is an image-quality and sound-quality optimum parameter that exhibits coincidence with the parameter request information in the “chapter” category but relates to another scene, image-quality and sound-quality can be adjusted corresponding to the request content.

### Third Exemplary Embodiment

A third exemplary embodiment of the invention will be described below with reference to the attached drawings.

In the third exemplary embodiment, a content output system including a content set value information acquiring device for adjusting image-quality in accordance with user's preference that differs depending on a genre, series, title and chapter of a content will be exemplarily described. Specifically, an arrangement for adjusting contrast, bright (brightness), color, sharpness, NR (noise reduction) and FRC (frame rate control) of an image will be exemplarily described. Alternatively, the content output system may adjust sound-quality corresponding to a genre, series, title and chapter.

Incidentally, the components same as those of the first and second exemplary embodiments will be denoted by the same numerals and names, and the description thereof will be omitted or simplified.

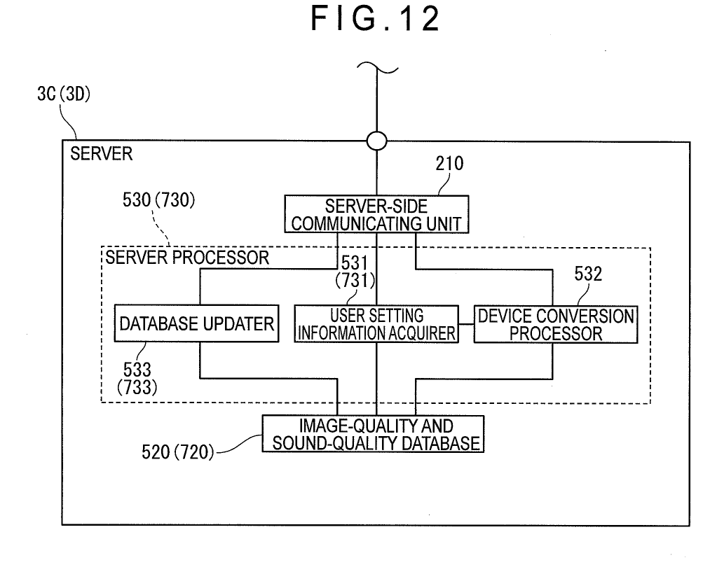

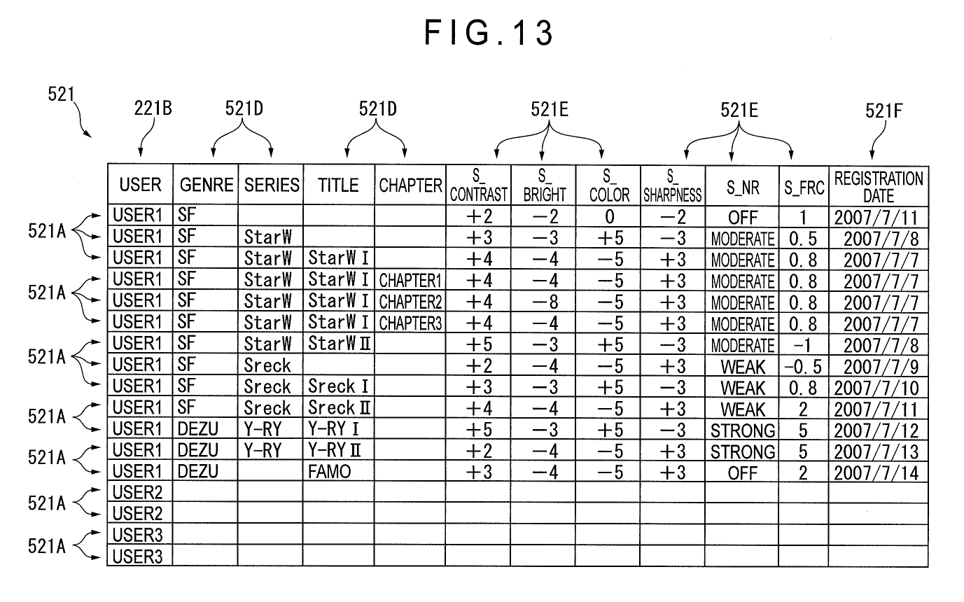

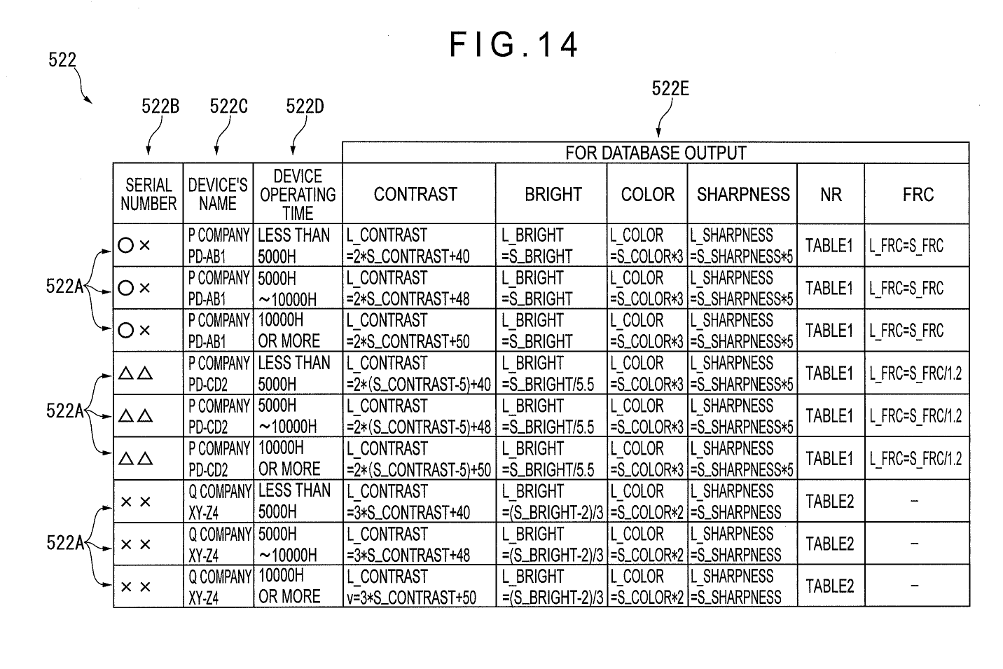

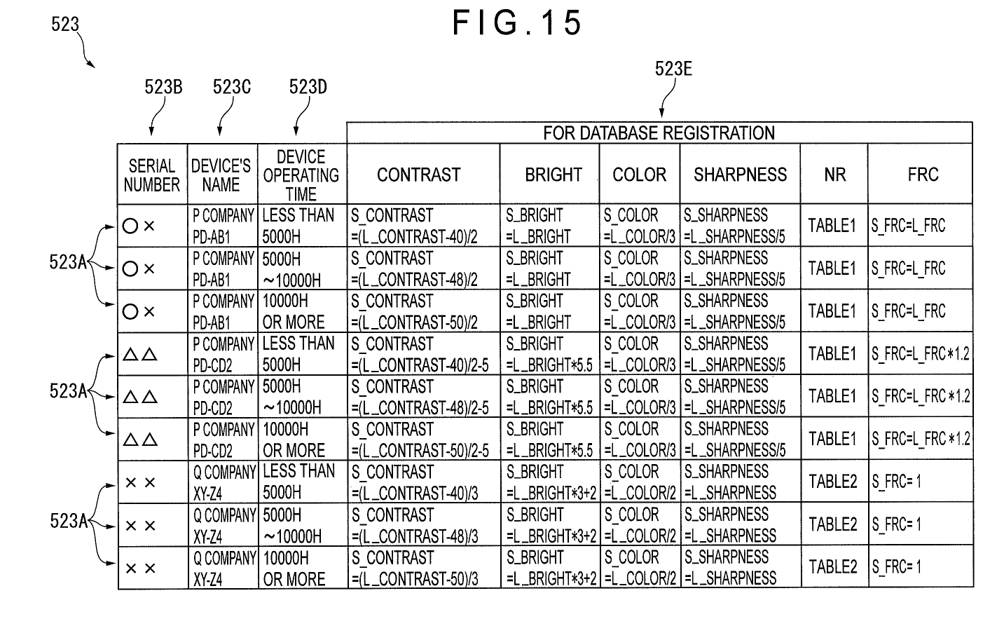

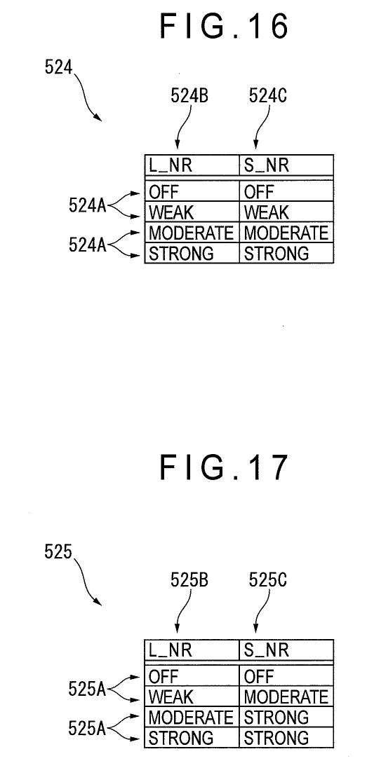

FIG. 12 is a block diagram schematically showing an arrangement of a server. FIG. 13 schematically shows an arrangement of a user database. FIG. 14 schematically shows an arrangement of an output conversion information database. FIG. 15 schematically shows an arrangement of a registration conversion information database. FIG. 16 schematically shows an arrangement of a first NR conversion table. FIG. 17 schematically shows an arrangement of a second NR conversion table.

### [Arrangement of Content Output System]

As shown in FIG. 1, 1C denotes the content output system. The content output system 1C includes: a network N; at least one display 2C serving as an output device; a server 3C serving as a content set value information acquiring device; a PC 4; an EWS 5; and a microwave 6.

As shown in FIG. 2, the display 2C has substantially the same arrangement as the display 2A of the first and second exemplary embodiments. A parameter request information acquirer 472 serving as a request information transmitter of an automatic setting unit 470 has an arrangement different from that of the first and second exemplary embodiments.

The parameter request information acquirer 472 acquires an operating time information relating to cumulative operating time of the display 2C based on a measurement value measured by a timer or the like (not shown). Then, the parameter request information acquirer 472 transmits to the server 3C via the network N the content information, the user information 161, the device configuration information 162 and the operating time information as the parameter request information.

As shown in FIG. 12, the server 3C includes: a server-side communicating unit 210; an image-quality and sound-quality database 520 serving as an output mode registration information storage, an output conversion information storage and registration conversion information storage; and a server processor 530 serving as a computer.

The image-quality and sound-quality database 520 stores: at least one user database 521 as shown in FIG. 13; an output conversion information database 522 as shown in FIG. 14; a registration conversion information database 523 as shown in FIG. 15; a first NR conversion table 524 as shown in FIG. 16; and a second NR conversion table 525 as shown in FIG. 17.

A user database 521 is suitably updated by a server processor 530.

As shown in FIG. 13, the user database 521 includes at least one user parameter registration information 521A serving as an output mode registration information.

The user parameter registration information 521A includes: a registrant's name information 221B; a request content information 521D; an image-quality converted value information 521E; and an information registration date information 521F.

The request content information 521D is for identifying a series, title and chapter of a content as information for identifying at least a genre of the content.

The image-quality converted value information 521E indicates a contrast converted value, brightness converted value, color converted value, sharpness converted value and FRC converted value obtained by converting a contrast set value, brightness set value, color set value, sharpness set value and FRC set value that are set by the display 2C based on the registration conversion information database 523. Also, the image-quality converted value information 521E indicates an NR conversion state obtained by converting an NR setting state set by the display 2C based on the first and second NR conversion tables 524 and 525.

The information registration date information 521F indicates a date on which various information are registered in the user parameter registration information 521A.

The contrast set value, brightness set value, color set value, sharpness set value, FRC set value and NR setting state will be collectively referred to as an image-quality and sound-quality optimum parameter. Also, the contrast converted value, brightness converted value, color converted value, sharpness converted value, FRC converted value and NR conversion state will be collectively referred to as an image-quality and sound-quality converted value.

As shown in FIG. 14, the output conversion information database 522 includes at least one output conversion information 522A that stores information for converting the image-quality and sound-quality converted value into the image-quality and sound-quality optimum parameter.

The output conversion information 522A includes: an output serial number information 522B; an output device's name information 522C; an output device operating time information 522D; and an output conversion formula information 522E.

The output serial number information 522B is for specifying a serial number of the display 2C.

The output device's name information 522C is for specifying a manufacturer and type of the display 2C.

The output device operating time information 522D indicates cumulative operating time of the display 2C.

The output conversion formula information 522E relates to a conversion formula for converting the contrast converted value, brightness converted value, color converted value, sharpness converted value, FRC converted value into the contrast set value, brightness set value, color set value, sharpness set value and FRC set value. In FIGS. 14 and 15, for example, “L_contrast” represents the contrast set value and “S_contrast” represents the contrast converted value.

The output conversion formula information 522E is for referring to the first NR conversion table 524 or the second NR conversion table 525 when the NR conversion state is converted into the NR setting state.

As shown in FIG. 15, the registration conversion information database 523 includes at least one registration conversion information 523A that stores an information for converting the image-quality and sound-quality optimum parameter into the image-quality and sound-quality converted value.

The registration conversion information 523A includes: a registration serial number information 523B; a registration device's name information 523C; a registration device operating time information 523D; and a registration conversion formula information 523E.

The registration serial number information 523B, registration device name information 523C and registration device operating time information 523D are the same as the output serial number information 522B, output device name information 522C and output device operating time information 522D.

The registration conversion formula information 523E relates to a conversion formula for converting the contrast set value, brightness set value, color set value, sharpness set value and FRC set value into the contrast converted value, brightness converted value, color converted value, sharpness converted value and FRC converted value.

The registration conversion formula information 523E is for referring to the first NR conversion table 524 or the second NR conversion table 525 when the NR setting state is converted into the NR registration state.

Incidentally, an output conversion formula and a registration conversion formula to be adopted may differ depending on duration of use of the display 2C, i.e., deterioration of the display 2C.

As shown in FIGS. 16 and 17, the first and second NR conversion tables 524 and 525 include at least one NR conversion information 524A and 525A for converting the NR setting state and NR registration state into one another.

The NR conversion information 524A, 525A includes: an NR setting state information 524B, 525B in which an NR setting state is stored; and an NR conversion state information 524C, 525C in which an NR conversion state is stored.

As shown in FIG. 12, the server processor 530 includes: a user setting information acquirer 531 serving as a user's user information acquiring processor and an another person's information acquiring processor that also serve as a request information acquirer; a device conversion processor 532 serving as a content set value information generator and a content set value information transmitter; and a database updater 533 serving as an updating unit, both of which are installed as a program.

The user setting information acquirer 531 acquires an image-quality and sound-quality converted value corresponding to a predetermined user and request content.

Specifically, the user setting information acquirer 531 acquires the content information, the user information 161 and the device configuration information 162 of the parameter request information. Then, the user setting information acquirer 531 recognizes a content-related information of the request content based on the content information.

The user setting information acquirer 531 further performs the same processing as the user setting information acquirer 331 of the second exemplary embodiment to acquire an image-quality and sound-quality converted value corresponding to the display 2C that has transmitted the parameter request information as the user's user setting information.

When the user setting information acquirer 531 cannot acquire the user's user setting information, the user setting information acquirer 531 acquires an another person's user setting information for another person having similar preference to a user.

In short, the user setting information acquirer 531 retrieves the user parameter registration information 521A including an another person's user name and a content of the lowest category of the request content. When the retrieved user parameter registration information 521A includes an image-quality and sound-quality converted value, the user setting information acquirer 531 determines whether an image-quality and sound-quality converted value relating to other contents corresponds to an image-quality and sound-quality converted value relating to other contents of a user requesting the image-quality and sound-quality optimum parameter. When such values are coincident, the user setting information acquirer 531 acquires an another person's image-quality and sound-quality converted value relating to the request content as the another person's user setting information.

When the user setting information acquirer 531 cannot acquire the user's user setting information or the another person's user setting information, the user setting information acquirer 531 acquires a default value set in advance as the user setting information.

The acquired user setting information is outputted to the device conversion processor 532.

The device conversion processor 532 is connected to the server-side communicating unit 210, the image-quality and sound-quality database 520 and the like.

The device conversion processor 532 converts the image-quality and sound-quality converted value based on the user setting information into the image-quality and sound-quality optimum parameter.

Specifically, the device conversion processor 532 acquires the image-quality and sound-quality converted value as the user setting information from the user setting information acquirer 531. The device conversion processor 532 also acquires the device configuration information 162 of the parameter request information and operating time information via the server-side communicating unit 210. Further, the device conversion processor 532 retrieves the output conversion information 522A including a content corresponding to the device configuration information 162 and operating time information from the output conversion information 522. Then, the image-quality and sound-quality converted value is converted into the image-quality and sound-quality optimum parameter based on an output conversion formula of the output conversion information 522A. In short, the device conversion processor 532 performs a device conversion processing.

Then, the image-quality and sound-quality optimum parameter is transmitted to the display 2C corresponding to the parameter request information via the network N.

The database updater 533 updates the user parameter registration information 521A of a predetermined user.

Specifically, the database updater 533 acquires a corrected image-quality and sound-quality parameter and parameter request information transmitted from a predetermined display 2C. The database updater 533 further retrieves the registration conversion information 523A including a content corresponding to the device configuration information 162 and operating time information from the registration conversion information database 523. Then, the database updater 533 converts the corrected image-quality and sound-quality parameter into the image-quality and sound-quality converted value based on a registration formula of the registration conversion information 523A.

Further, the database updater 533 retrieves the user parameter registration information 521A relating to the lowest category of the request content corresponding to the user information 161, and updates the image-quality and sound-quality converted value of the user parameter registration information 521A.

### [Operation of Content Output System]

Next, an operation of the content output system 1C will be described.

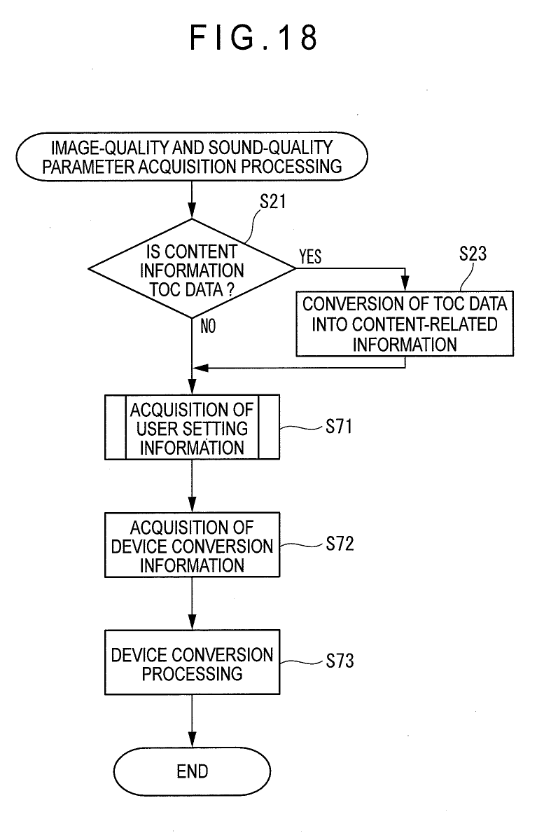

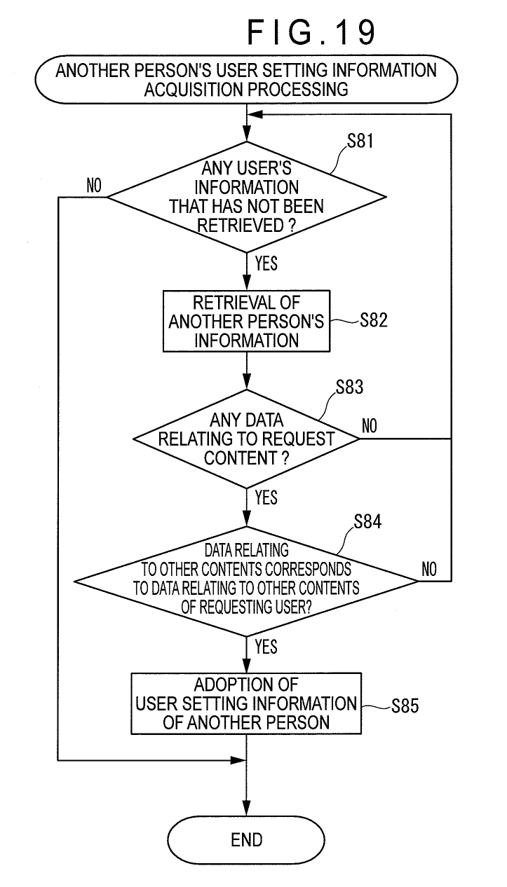

FIG. 18 is a flow chart schematically showing an image-quality and sound-quality optimum parameter acquisition processing. FIG. 19 is a flowchart showing an another person's user setting information acquisition processing.

Processing(s) except for the image-quality and sound-quality optimum parameter acquisition processing and the another person's user setting information acquisition processing is the same as that of the first and second exemplary embodiments, and the description thereof will be simplified.

The content output system 1C performs: the image-quality and sound-quality adjustment processing as shown in FIG. 5; the user setting information acquisition processing as shown in FIG. 7; and the user's user setting information acquisition processing as shown in FIG. 11.

The display 2C acquires the content information, the user information 161, the device configuration information 162 and the operating time information in the steps S1 and S2 of the image-quality and sound-quality adjustment processing as the parameter request information, and transmits them to the server 3C.

Then, in the acquisition processing of the image-quality and sound-quality optimum parameter in the step S3, the server 3C acquires the user setting information when determining that the content information is not TOC data in the step S21 as shown in FIG. 18 (step S71). When determining that the content information is TOC data in the step S21, the server 3C performs the processing of the step S23 and then performs the processing of the step S71.

When acquiring the user setting information in the step S71, the server 3C acquires the output conversion formula as the device conversion information from the output conversion information 522A corresponding to the parameter request information (step S72). Then, the server 3C performs the device conversion processing based on the output conversion formula and the image-quality and sound-quality converted value that is the user setting information (step S73), and acquires the image-quality and sound-quality optimum parameter.

Further, in the acquisition processing of the another person's user setting information of the user setting information acquisition processing in the step S33, the server 3C determines whether the user parameter registration information 521A of a user that has not been retrieved exists as shown in FIG. 19 (step S81). When determining that the server 3C has retrieved all of the user parameter registration information 521A of the user in the step S81, the server 3A ends the processing without acquiring the another person's user setting information. On the contrary, when determining that the server 3C has not retrieved all of the user parameter registration information 521A of the user in the step S81, the server 3C starts to retrieve the user parameter registration information 521A of another person (step S82) and determines whether data relating to the request content (image-quality and sound-quality converted value) exists in the user parameter registration information 521A of the another person (step S83).

When the server 3C determines that such data relating to the request content does not exist in the step S83, the processing is returned to the step S81. On the contrary, when determining that such data relating to the request content exists in the step S83, the server 3C determines whether data relating to the other contents corresponds to data relating to the other contents of a user requesting the image-quality and sound-quality optimum parameter (step S84). When determining that such data are coincident in the step S84, the server 3C acquires the image-quality and sound-quality converted value of the person as the another person's user setting information (step S85). On the contrary, when determining that such data are not coincident in the step S84, the processing is returned to the step S81.

### [Advantages of Third Exemplary Embodiment]

In the third exemplary embodiment as described above, the following advantages can be obtained in addition to the advantages of the first and second exemplary embodiments.

When acquiring the image-quality and sound-quality converted value of a user or another person from the user parameter registration information 521A, the server 3C converts the image-quality and sound-quality converted value into the image-quality and sound-quality optimum parameter based on the output conversion formula of the output conversion information 522A corresponding to the type of the display 2C and transmits such optimum parameter to the display 2C.

Accordingly, for example, even when the type of the display 2C is changed because of replacement or the like, a content of which image-quality and sound-quality are adjusted to be the same as the original type of the display 2C can be outputted by converting the originally-set image-quality and sound-quality converted value based on an output conversion formula corresponding to a new type of the display 2C. Thus, user-friendliness can be enhanced.

Further, since the user parameter registration information 521A does not need to include an information relating to a type of the display 2C, an amount of data in the user parameter registration information 521A can be reduced.

When acquiring the corrected image-quality and sound-quality parameter and parameter request information from the display 2C, the server 3C converts the corrected image-quality and sound-quality parameter into the image-quality and sound-quality converted value based on the registration conversion formula of the registration conversion information 523A corresponding to the type of the display 2C. Then, the server 3C updates the image-quality and sound-quality optimum parameter of the user parameter registration information 521A corresponding to a user of the display 2C into the image-quality and sound-quality converted value.

Accordingly, even when the user changes his preference, an image-quality and sound-quality optimum parameter that meets the preference can be newly stored in the server 3C. Thus, user-friendliness can be enhanced. Difference in types of the display 2C may entail difference in image-quality and sound-quality optimum parameters even though the adjusted states of the parameters are substantially the same. At this time, the image-quality and sound-quality optimum parameters can be converted into the image-quality and sound-quality converted values to be substantially the same Thus, preferences of users each having the display 2C of a different type can be easily compared to each other.

A different output conversion formula and registration conversion formula are used depending on duration of use of the display 2C, i.e., deterioration of the display 2C.

Accordingly, even when the display state of the display unit 120 or the sound output state of the sound output unit 130 are deteriorated due to deterioration of the display 2C, the display 2C can acquire an image-quality and sound-quality optimum parameter corresponding to such deterioration state, the optimum parameter being different from an image-quality and sound-quality optimum parameter before the deterioration. Thus, a content of which image-quality and sound-quality are adjusted to be the same as before the deterioration can be outputted, thereby enhancing user-friendliness.

### Fourth Exemplary Embodiment

A fourth exemplary embodiment of the invention will be described below with reference to the attached drawings.

In the fourth exemplary embodiment, a content output system including a content set value information acquiring device for adjusting image-quality in accordance with user's preference that differs depending on a genre, series, title and chapter of a content will be exemplarily described. Also, the content output system for adjusting image-quality based on data obtained by statistical processing of plural users' preference will be exemplarily described. Alternatively, the content outputs system may adjust sound-quality according to a genre, series, title and chapter.

Incidentally, the components same as those of the first to third exemplary embodiments will be denoted by the same numerals and names, and the description thereof will be omitted or simplified.

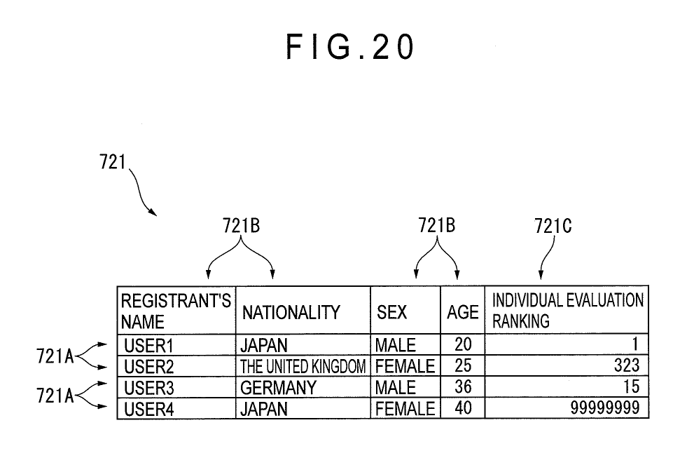

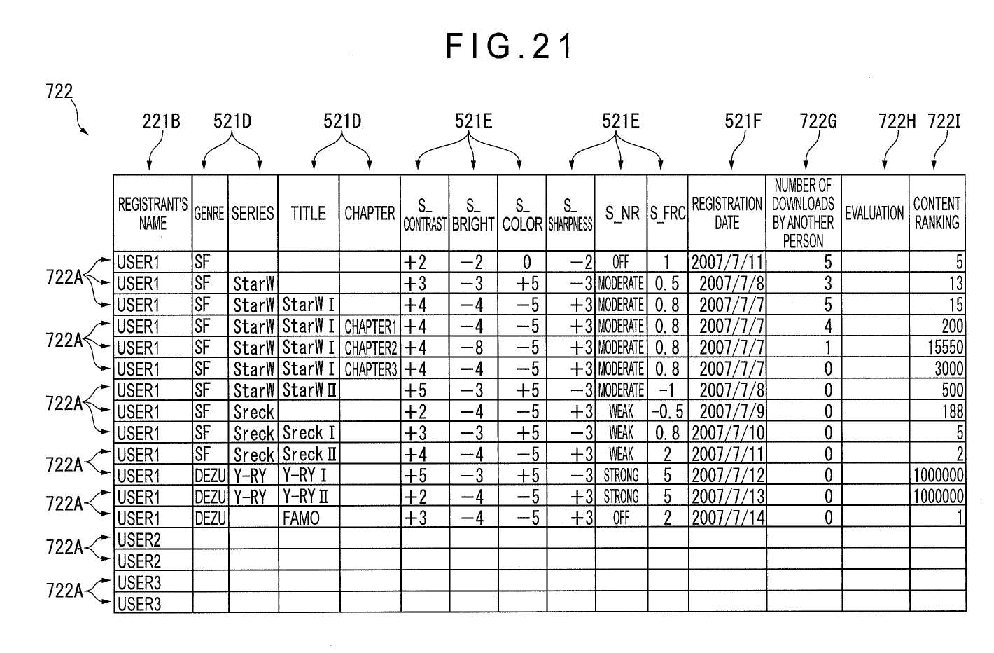

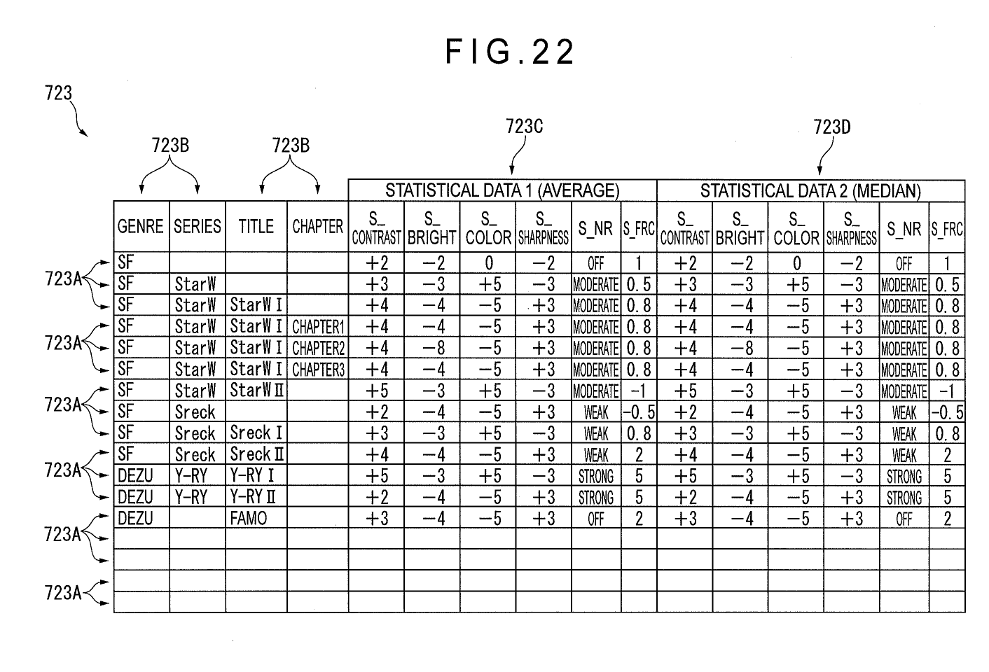

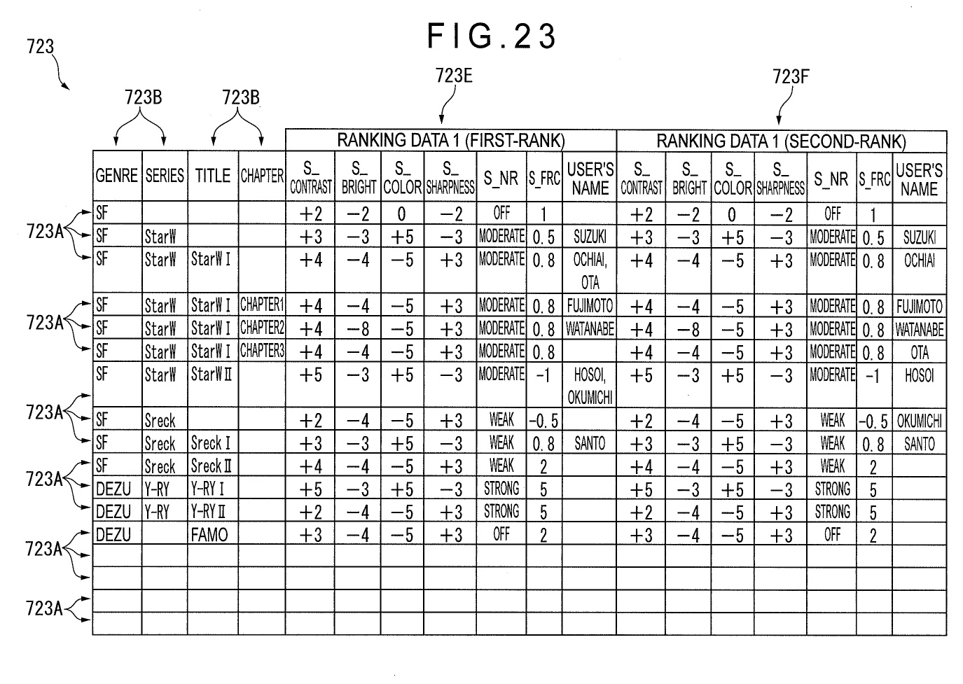

FIG. 20 schematically shows an arrangement of a user-related information database. FIG. 21 schematically shows an arrangement of a user database. FIGS. 22 and 23 schematically show an arrangement of a statistical database.

### [Arrangement of Content Output System]

As shown in FIG. 1, 1D denotes the content output system. The content output system 1D includes: a network N; at least one display 2D serving as an output device; a server 3D serving as a content set value information acquiring device; a PC 4; an EWS 5; and a microwave 6.

As shown in FIG. 2, the display 2D has substantially the same arrangement as the displays 2A and 2C of the first to third exemplary embodiments. A parameter request information acquirer 672 serving as a request information transmitter of an automatic setting unit 670 has an arrangement different from that of the first to third exemplary embodiments.

The parameter request information acquirer 672 generates a parameter selection information for acquiring any one of an image-quality and sound-quality optimum parameter of a user, an image-quality and sound-quality optimum parameter of another person and a statistically commonly-used image-quality and sound-quality optimum parameter based on the setting input by a user. Then, the parameter request information acquirer 670 transmits to the server 3D via the network N the content information, the user information 161, the device configuration information 162, the operating time information and the parameter selection information as the parameter request information.

As shown in FIG. 12, the server 3D includes: a server-side communicating unit 210; an image-quality and sound-quality database 720 serving as an output mode registration information storage, an output conversion information storage and registration conversion information storage; and a server processor 730 serving as a computer.

The image-quality and sound-quality database 720 stores: a user-related database 721 as shown in FIG. 20; a user database 722 as shown in FIG. 21; a statistical database 723 as shown in FIGS. 22 and 23; an output conversion information database 522 as shown in FIG. 14; a registration conversion information database 523 as shown in FIG. 15; a first NR conversion table 524 as shown in FIG. 16; and a second NR conversion table 525 as shown in FIG. 17.

As shown in FIG. 20, the user-related information database 721 includes at least one user-related information 721A.

The user-related information 721A includes a user unique information 721B and an individual evaluation ranking information 721C.

The user unique information 721B includes information specific to a user such as a name, nationality, sex and age of the user.

The individual evaluation ranking information 721C includes the number of times another user adopts his image-quality and sound-quality converted value, i.e., a ranking based on the number of times the image-quality and sound-quality optimum parameter of the user is downloaded by another person.

As shown in FIG. 21, the user database 722 includes at least one user parameter registration information 722A serving as an output mode registration information.

The user parameter registration information 722A includes: a registrant's name information 221B; a request content information 521D; an image-quality converted value information 521E; an information registration date information 521F; an another person's download frequency information 722G; an evaluation information 722H; and a content rank information 722I.

The another person's download frequency information 722G indicates the number of times an image-quality and sound-quality converted value corresponding to the user parameter registration information 722A is downloaded by another person.

The evaluation information 722H indicates an evaluation of the image-quality and sound-quality by the another user.

The content rank information 722I indicates an evaluation rank of the image-quality and sound-quality converted value of a content. The evaluation rank is set based on the number of downloads by another person and evaluation by the another person.

As shown in FIGS. 22 and 23, the statistical database 723 includes at least one statistical data registration information 723A.

The statistical data registration information 723A includes: a request content information 723B; an average data information 723C; a median data information 723D; a top-ranked data information 723E; and a second-ranked data information 723F. Though the average data information 723C and median data information 723D and the top-ranked data information 723E and second-ranked data information 723F are shown to have different structures in FIGS. 22 and 23, such informations are arranged to have one data structure.

The request content information 723B is the same as the request content information 521D of the user database 722.

The average data information 723C and median data information 723D respectively indicate an average value and a median (central value) when plural users' image-quality and sound-quality converted values are statistically processed. The average data information 723C and median data information 723D respectively indicate average values and medians of a contrast converted value, brightness converted value, color converted value, sharpness converted value, NR conversion state and FRC converted value.

The top-ranked data information 723E and second-ranked data information 723F respectively indicate a top-ranked image-quality and sound-quality converted value and a second-ranked image-quality and sound-quality converted value when plural users' image-quality and sound-quality converted values are statistically processed. The evaluation rank is set based on the number of downloads by another person and evaluation by the another person. The top-ranked and second-ranked data informations 723E and 723F respectively indicate: top-ranked and second-ranked values of a contrast converted value, brightness converted value, color converted value, sharpness converted value, NR conversion state and FRC converted value; and names of users who register the top-ranked and second-ranked values.

The average data information 723C and the median data information 723D will be collectively referred to as summary data. Also, the top-ranked and second-ranked data information 723E and 723F will be collectively referred to as ranking data.

As shown in FIG. 12, the server processor 730 includes: a user setting information acquirer 731 serving as a user's user information acquiring processor and an another person's information acquiring processor that also serve as a request information acquirer; a device conversion processor 532; and a database updater 733 serving as an updating unit, all of which are installed as a program.

The user setting information acquirer 731 acquires an image-quality and sound-quality converted value corresponding to a predetermined user and a request content as the user setting information.

Specifically, the user setting information acquirer 731 acquires the content information of the parameter request information, the user information 161, the device configuration information 162 and the parameter selection information. Further, the user setting information acquirer 731 recognizes a content-related information of the request content based on the content information.

Based on the parameter selection information, the user setting information acquirer 731 acquires a user setting information of a user of the display 2A that has transmitted the parameter request information, an another person's user setting information and a user setting information based on statistical data.

When acquiring the user's and another person's user setting informations, the user setting information acquirer 731 performs the same processing as the user setting information acquirer 531 of the third exemplary embodiment to acquire an image-quality and sound-quality converted value as the user setting information.

When acquiring the user setting information based on the statistical data, the user setting information acquirer 731 retrieves the statistical data registration information 723A including a content of the lowest category of the request content. When the acquired user setting information is the summary data, the user setting information acquirer 731 acquires an average value or median as the user setting information based on the request of the user.

Further, when the acquired user setting information is the ranking data, the user setting information acquirer 731 acquires the top-ranked or second-ranked image-quality and sound-quality converted value as the user setting information based on the request of the user.

The database updater 733 updates the user parameter registration information 722A and the statistical data registration information 723A of a predetermined user.

Specifically, the database updater 733 performs the same processing as the database updater 533 of the third exemplary embodiment to perform the image-quality and sound-quality converted value updating processing of the user parameter registration information 722A based on the corrected image-quality and sound-quality parameter.

Also, when the user setting information acquirer 731 acquires the another person's user setting information, the database updater 733 increments the number of downloads by the another person while sorting the ranking data of the statistical data registration information 723A in response to the increment to suitably update the top-ranked and second-ranked data.

For example, when an image-quality and sound-quality converted value of a user 2 is acquired as the another person's user setting information, the number of downloads by the another person in the user parameter registration information 722A corresponding to the request content of the user 2 is incremented.

Further, when the user setting information acquirer 731 acquires the user setting information based on the ranking data, the database updater 733 recognizes a user name included in the statistical data registration information 723A of the ranking data. Then, the data updater 733 increments the number of downloads by another person in the user parameter registration information 722A corresponding to the user name while sorting the ranking data of the statistical data registration information 723A corresponding to the increment.

For example, when the top-ranked data is acquired as the user setting information, the data updater 733 recognizes the user name included in the statistical data registration information 723A of the top-ranked data and increments the number of downloads by the another person in the user parameter registration information 722A corresponding to the user name and the request content.

### [Operation of Content Output System]

Next, an operation of the content output system 1D will be described.

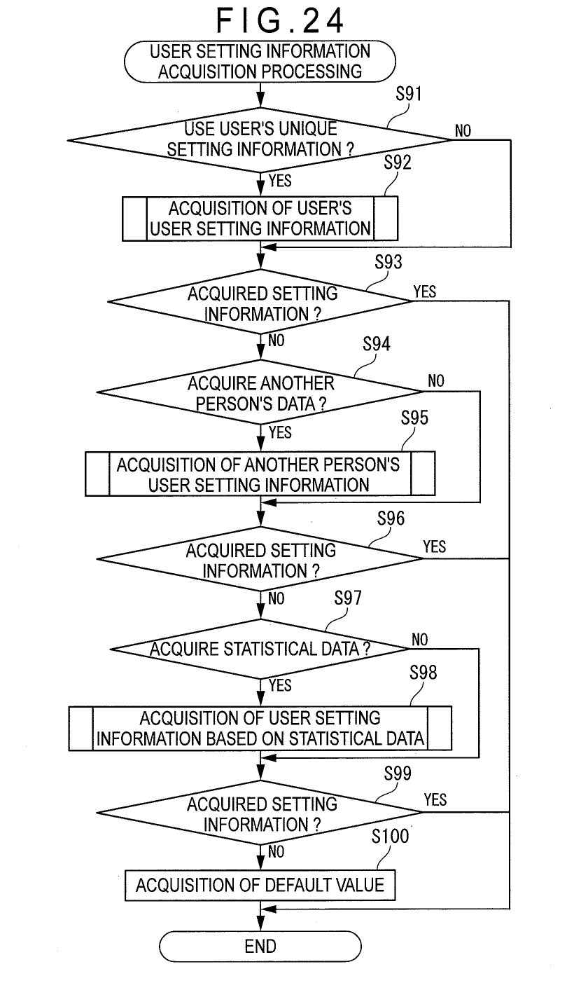

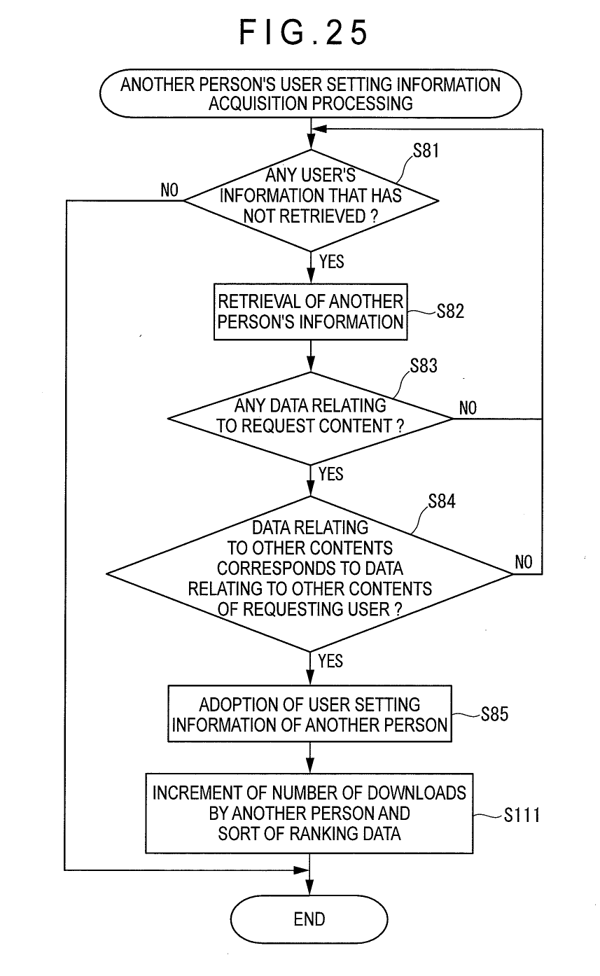

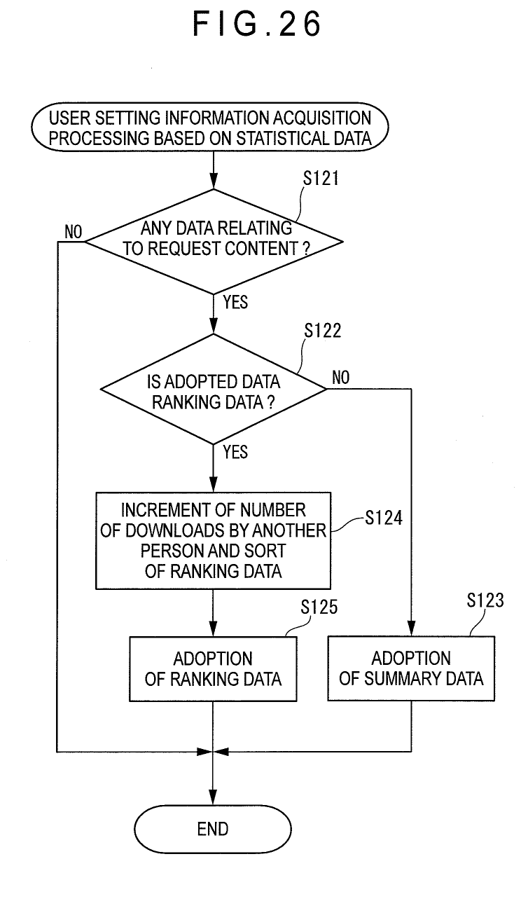

FIG. 24 is a flowchart showing a user setting information acquisition processing. FIG. 25 is a flowchart showing an another person's user setting information acquisition processing. FIG. 26 is a flowchart showing a user setting information acquisition processing based on statistical data.

Processing(s) except for the user setting information acquisition processing, the another person's setting information acquisition processing and the user setting information acquisition processing based on the statistical data is the same as that of the third exemplary embodiment, and the description thereof will be simplified.

The content output system 1D performs: the image-quality and sound-quality adjustment processing as shown in FIG. 5; the image-quality and sound-quality optimum parameter acquisition processing as shown in FIG. 18; and the user's user setting information acquisition processing as shown in FIG. 11.

The display 2D acquires the content information, the user information 161, the device configuration information 162, the operating time information and the parameter selection information as the parameter request information in the steps S1 and S2 of the image-quality and sound-quality adjustment processing, and transmits them to the server 3D.

Further, in the user setting information acquisition processing of the image-quality and sound-quality optimum parameter acquisition processing in the step S71, the server 3D determines whether to use a user setting information unique to a user based on the parameter selection information as shown in FIG. 24 (step S91). When determining to use such information in the step S91, the server 3D performs the user's user setting information acquisition processing (step S92). On the contrary, when determining not to use such information in the step 91 or when performing the user setting information acquisition processing in the step S92, the server 3D determines whether or not the server 3D has been able to acquire the user setting information.

When the server 3D determines that the server 3D has been able to acquire such information in the step S93, the processing is terminated. On the contrary, when determining that the server 3D has been unable to acquire such information, the server 3D determines whether to use an another person's user setting information (step S94). When determining to use such information in the step S94, the server 3D performs the another person's user setting information acquisition processing (step S95). On the contrary, when determining not to use such information in the step S94 or when performing the user setting information acquisition processing in the step S95, the server 3D determines whether the server 3D has been able to acquire the user setting information (step S96).

When the server 3D determines that the server 3D has been able to acquire such information in the step S96, the processing is terminated. On the contrary, when determining that the server 3D has been able to acquire such information in the step S96, the server 3D determines whether or not to use a user setting information of statistical data (step S97). When determining to use such information in the step S97, the server 3D performs the user setting information acquisition processing based on the statistical data (step S98). On the contrary, when determining not to use such information in the step S97 or when performing the user setting information acquisition processing in the step S98, the server 3D determines whether the server 3D has been able to acquire the user setting information (step S99).

When the server 3D determines that the server 3D has been able to acquire such information in the step S99, the processing is terminated. On the contrary, when determining that the server 3D has been unable to acquire such information in the step S99, the server 3D acquires a default value as the user setting information (step S100) and ends the processing.

Further, in the another person's user setting information acquisition processing of the user setting information acquisition processing in the step S95, the server 3D performs the steps S81 to S85 that are the same as those of the third exemplary embodiment. When acquiring an image-quality and sound-quality converted value as an another person's user setting information in the step S85, the server 3D increments the number of downloads by another person while sorting the ranking data (step S111), and ends the processing.

Further, in the user setting information acquisition processing based on the statistical data of the user setting information acquisition processing in the step S98, the server 3D determines whether data relating to the request content exists as shown in FIG. 26 (step S121). When the server 3D determines that such data does not exist in the step S121, the processing is terminated. On the contrary, when determining that such data exists in the step S121, the server 3D determines whether or not to acquire the ranking data as the user setting information (step S122).

When determining to acquire the summary data in the step S122, the server 3D acquires an average value and median of the summary data as the user setting information based on the statistical data (step S123). When determining to acquire the ranking data in the step S122, the server 3D increments the number of times data of a user including the top-ranked and second-ranked data to be acquired is downloaded by the another person while sorting the ranking data (step S124). Then, the server 3D acquires the ranking data as the user setting information based on the statistical data (step S125).

### [Advantages of Fourth Exemplary Embodiment]

In the fourth embodiment as described above, the following advantages can be obtained in addition to the advantages of the first to third embodiments.

The server 3D transmits to the display 2D the image-quality and sound-quality optimum parameter based on the value obtained by statistically processing the plural users' image-quality and sound-quality converted values.

Accordingly, even when the display 2D cannot acquire the image-quality and sound-quality optimum parameters of the user or another person, the display 2D can acquire the image-quality and sound-quality based on the statistical processing. Thus, problems in acquiring the image-quality and sound-quality optimum parameter can be prevented and therefore comfortable space for viewing can be provided. Further, choices of image-quality and sound-quality parameters can be broadened for a user.

Then, the server 3D transmits the average value of the image-quality and sound-quality parameter to the display 2D.

Accordingly, the display 2D can output a content of which image-quality and sound-quality are adjusted to be average so as to meet plural users' preference.

Further, the server 3D transmits the median of the image-quality and sound-quality optimum parameter to the display 2D.

When the server 3D transmits the average value, the average value may not necessarily reflect entire tendency if average values are extremely different depending on users. In contrast, when the server 3D transmits the median, the display 2D can reflect entire tendency and output a content having image-quality and sound-quality to meet the plural users' preference even if there are extremely different values.

Further, the server 3D transmits a top-ranked or second-ranked image-quality and sound-quality optimum parameter to the display 2D.

Accordingly, the display 2D can output a content having image-quality and sound-quality to meet many users' preference.

The server 3D is provided with the statistical database 723 and updates the statistical database 723 every time the server 3D transmits the image-quality and sound-quality optimum parameter to the display 2D.

Thus, when a new image-quality and sound-quality optimum parameter is requested to be transmitted, it is only required for the server 3D to acquire such parameter from the statistical database 723. Thus, processing load can be reduced as compared to an arrangement for performing statistical processing for every transmission request.

### Fifth Exemplary Embodiment

A fifth exemplary embodiment of the invention will be described below with reference to the attached drawings.

In the fifth exemplary embodiment, a content output system including a content set value information acquiring device for adjusting image-quality and sound-quality in accordance with user's preference that differs depending on contents will be exemplarily described. Specifically, an arrangement for adjusting a contrast of an image and an output level of sound will be described.

Incidentally, the components same as those of the first to fourth exemplary embodiments will be denoted by the same numerals and names, and the description thereof will be omitted or simplified.

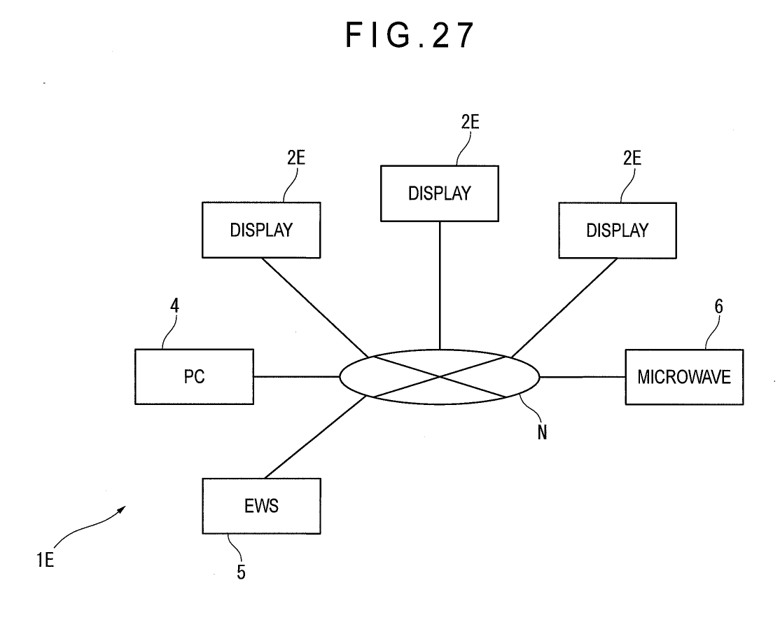

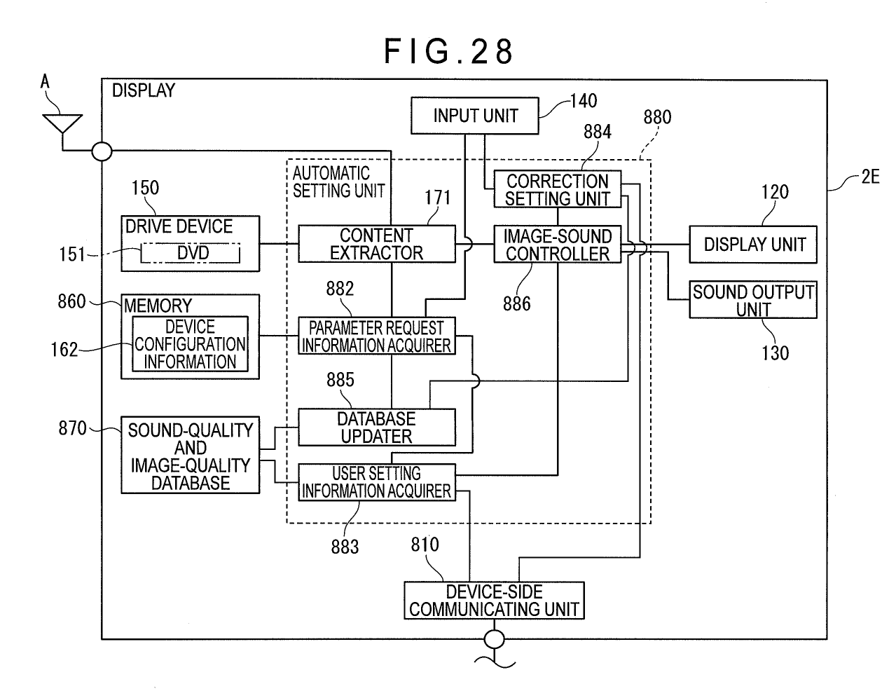

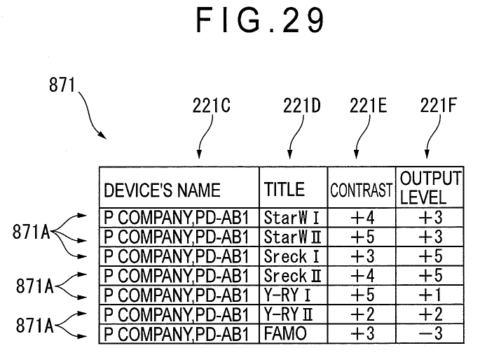

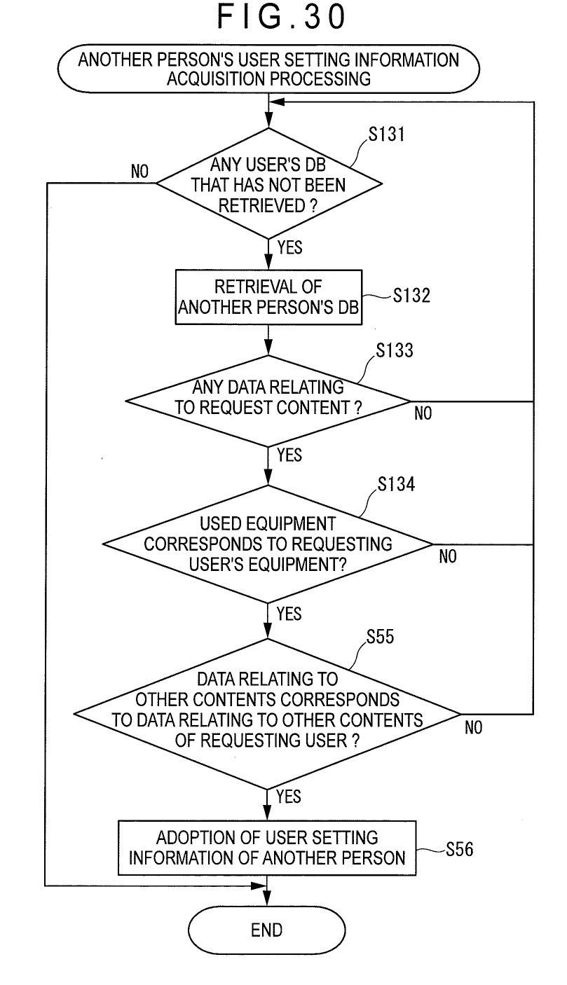

FIG. 27 is a block diagram schematically showing an arrangement of the content output system. FIG. 28 is a block diagram schematically showing an arrangement of a display. FIG. 29 schematically shows an arrangement of a user database.

### [Arrangement of Content Output System]

As shown in FIG. 27, 1E denotes the content output system. The content output system 1E includes: a network N; at least one display 2E serving as an output device; a PC 4; an EWS 5; and a microwave 6. In other words, the content output system 1E does not include the servers 3A to 3D provided in the content output systems 1A to 1D of the first to fourth exemplary embodiments.

As shown in FIG. 28, the display 2E includes: a device-side communicating unit 810; a display unit 120; a sound output unit 130; an input unit 140; a drive device 150; a memory 860; an image-quality and sound-quality database 870 serving as an output mode registration information storage; and an automatic setting unit 880 serving as a content set value information acquiring device and computer.

The device-side communicating unit 810 is connected to the network N for sending and receiving informations to and from the display 2E, PC 4, EWS 5 and microwave 6.

Specifically, the device-side communicating unit 810 receives information transmitted from the display 2E, PC 4, EWS 5 and microwave 6 to output the information to the automatic setting unit 880, and receives information from the automatic setting unit 880 to output the information to the display 2E, PC 4, EWS 5 and microwave 6.

The memory 860 includes the device configuration information 162.

The image-quality and sound-quality database 870 stores a user database 871 as shown in FIG. 29.

The user database 871 is suitably updated by the automatic setting unit 880.

The user database 871 includes at least one user parameter registration information 871A serving as an output mode registration information.

The user parameter registration information 871A includes the user device's name information 221C, the request content information 221D, the image-quality set value information 221E and the sound-quality set value information 221F. In other words, the user parameter registration information 871A includes information only relating to a user of the display 2E and does not include information relating to another person.

As shown in FIG. 28, the automatic setting unit 880 includes: a content extractor 171; a parameter request information acquirer 882 serving as a request information transmitter; a user setting information acquirer 883 serving as a user's user information acquiring processor and an another person's information acquiring processor that also serve as a request information acquirer, content set value information generator and content set value information transmitter; a correction setting unit 884; a database updater 885; and an image-sound controller 886 serving as an output mode controller, all of which are installed as a program.

The parameter request information acquirer 882 is connected to the input unit 140, the memory 860, the user setting information acquirer 883, the database updater 885 and the like.

The parameter request information acquirer 882 acquires the content information based on TOC data or EPG data while acquiring the device configuration information 162 from the memory 860. Then, the content information and the device configuration information 162 are outputted to the user setting information acquirer 883 as the parameter request information.

The user setting information acquirer 883 is connected to the device-side communicating unit 810, the image-quality and sound-quality database 870 and the like.

The user setting information acquirer 883 acquires an image-quality and sound-quality optimum parameter corresponding to a request content as the user setting information.

Specifically, the user setting information acquirer 883 acquires a parameter request information from the parameter request information acquirer 882. Further, the user setting information acquirer 883 recognizes a content-related information relating to the request content based on the content information.

The user setting information acquirer 883 acquires a user setting information of a user of the display 2E.

In other words, the user setting information acquirer 883 retrieves the user parameter registration information 871A including a title of the request content, and then acquires an image-quality and sound-quality optimum parameter as the user's user setting information when the retrieved user parameter registration information 871A includes the image-quality and sound-quality optimum parameter.

When the user setting information acquirer 883 cannot acquire the user's user setting information, the user setting information acquirer 883 acquires a user setting information of another person having similar preference to the user.

The user setting information acquirer 883 outputs a reference request information for requesting the reference of the user database 871 to another display 2E via the network N. The user setting information acquirer 883 further acquires the user database 871 corresponding to the reference request information via the network N. Then, the user setting information acquirer 883 retrieves the user parameter registration information 871A including a content of the device configuration information 162 and a title of the request content from the user database 871. When the retrieved user parameter registration information 871A includes image-quality and sound-quality optimum parameters, the user setting information acquirer 883 determines whether an another person's image-quality and sound-quality optimum parameter relating to the other contents corresponds to a user's image-quality and sound-quality optimum parameter relating to the other contents. When such information are coincident, the user setting information acquirer 883 acquires an another person's image-quality and sound-quality optimum parameter relating to the request content as an another person's setting information.

When the user setting information acquirer 883 cannot acquire the user's user setting information or the another person's user setting information, the user setting information acquirer 883 acquires a default value set in advance as the user setting information.

The image-quality and sound-quality optimum parameter that is the acquired user setting information is outputted to the image-sound controller 886.

When acquiring the reference request information from another display 2E, the user setting information acquirer 883 transmits the user database 871 to the another display 2E.

Incidentally, the display 2E, PC 4, EWS 5 and microwave 6 are connected to the network N. Accordingly, when the reference request information is transmitted to a device other than the display 2E, the user database 871 is not returned. Thus, for example, when the user database 871 is not returned after the elapse of a predetermined period after the reference request information is transmitted, it is preferable that the reference request information is transmitted to a device other than the device to which the information has been transmitted before.

The correction setting unit 884 is connected to the device-side communicating unit 810, the input unit 140, the database updater 885, the image-sound controller 886 and the like.

The correction setting unit 884 outputs to the image-sound controller 886 a corrected image-quality and sound-quality parameter corrected and set by a user based on an input operation by the input unit 140. Further, when recognizing that the corrected image-quality and sound-quality parameter is to be registered in the user database 871, the correction setting unit 884 outputs the corrected image-quality and sound-quality parameter to the database updater 885 and controls the parameter request information acquirer 882 to output the parameter request information to the database updater 885.

The database updater 885 is connected to the image-quality and sound-quality database 870 and the like.

The database updater 885 updates the user parameter registration information 871A.

Specifically, when acquiring the corrected image-quality and sound-quality parameter and parameter request information, the database updater 885 retrieves the user parameter registration information 871A including a title of the request content. Then, the image-quality and sound-quality optimum parameter of the retrieved user parameter registration information 871A is updated to the corrected image-quality and sound-quality parameter.

The image-sound controller 886 is connected to the display unit 120, the sound output unit 130 and the like.

The image-sound controller 886 acquires content data from the content extractor 171 while acquiring an image-quality and sound-quality optimum parameter (i.e., the user setting information) from the user setting information acquirer 883. Then, based on the image-quality and sound-quality optimum parameter, the image-sound controller 886 controls the display unit 120 to display a quality-adjusted image of which a contrast is adjusted and the sound output unit 130 to output a quality-adjusted sound of which an output level is adjusted.

Further, the image-sound controller 886 suitably acquires the corrected image-quality and sound-quality parameter from the correction setting unit 884, and performs a display control of the quality-adjusted image and an output control of the quality-adjusted sound. Here, the quality-adjusted image and the quality-adjusted sound are corrected and set based on the acquired parameter.

### [Operation of Content Output System]

Next, an operation of the content output system 1E will be described.

FIG. 30 is a flowchart showing an another person's user setting information acquisition processing.

Processing(s) except for the another person's user setting information acquisition processing is the same as that of the first exemplary embodiment, and the description thereof will be simplified.

The content output system 1E performs: the image-quality and sound-quality adjustment processing as shown in FIG. 5; the image-quality and sound-quality optimum parameter acquisition processing as shown in FIG. 6; the user setting information acquisition processing as shown in FIG. 7; and the user's user setting information acquisition processing as shown in FIG. 8.

The parameter request information acquirer 882 of the display 2E acquires the content information and the device configuration information 162 as the parameter request information in the steps S1 and S2 of the image-quality and sound-quality adjustment processing, and transmits them to the user setting information acquirer 883. In the step S4, the user setting information acquirer 883 outputs to the image-sound controller 886 the image-quality and sound-quality optimum parameter that is the user setting information. Further, in the step S10, the corrected image-quality and sound-quality parameter is uploaded in the image-quality and sound-quality database 870.

In the another person's user setting information acquisition processing of the user setting information acquisition processing in the step S33, the display 2E determines the existence of the user databases 871 of users that have not been retrieved (step S131). When the display 2E determines that the user databases 871 of all the users have been retrieved in the step S131, the another person's user setting information is not acquired and the processing is terminated. On the contrary, when the display 2E determines that the user database 871 that have not been retrieved exist in the step S131, another person's user database 871 is retrieved (step S132) and whether data relating to the request content exists is determined (step S133).

When such data is determined not to exist in the step S133, the processing is returned to the step S131. On the contrary, when such data is determined to exist in the step S133, whether a device (display 2E) used by another person corresponds to a device used by the user requesting the image-quality and sound-quality optimum parameter is determined (step S134).

When such devices are determined not to be coincident in the step S134, the processing is returned to the step S131. On the contrary, when such devices are determined to be coincident in the step S134, whether data relating to the other contents corresponds to data relating to the other content of the user requesting the image-quality and sound-quality optimum parameter is determined (step S55). When such data are determined to be coincident in the step S55, the image-quality and sound-quality optimum parameter of the another person is acquired as the another person's user setting information. When determining such data are determined not to be coincident in the step S55, the processing is returned to the step S131.

### [Advantages of Fifth Exemplary Embodiment]

In the fifth embodiment as described above, the following advantages can be obtained in addition to the advantages of the first to fourth embodiments.

The content output system 1E is not provided with the server, and the user database 871 is provided in each display 2E. The user database 871 stores the user parameter registration information 871A relating only to the user of the display 2E. The image-quality and sound-quality optimum parameter of the user is acquired from the user database 871 of the display 2E, and the image-quality and sound-quality optimum parameter of another person is acquired from the user database 871 of another display 2E.

Thus, investments for system structure can be reduced to the minimum because the server is not provided. Further, because the user parameter registration information 871A does not need to include information relating to a type of the display 2C, an amount of data in the user parameter registration information 871A can be reduced.

### [Modifications of Exemplary Embodiment]

The invention is not limited to the first to fifth exemplary embodiments as described above, but includes other modifications and improvements as long as an object of the invention can be achieved.

In the second to fourth exemplary embodiments, when the user parameter registration information 321A, 521A, 722A relating to the lowest category does not include an image-quality and sound-quality optimum parameter, an image-quality and sound-quality optimum parameter of the user parameter registration information 321A, 521A, 722A corresponding to a second upper category or the uppermost category, not to an upper category, may be acquired.

Further, in the first and fifth exemplary embodiments, a function for acquiring a default value as the user setting information is not required.

In the first, second and fifth exemplary embodiments, for example, when the types of all of the displays 2A, 2E of the content output system 1A, 1B, 1E are the same, whether the display 2A, 2E has the same type as that of a user in acquiring the another person's user setting information. With such arrangement, processing load during the user setting information acquisition processing can be reduced.

In the first to fifth exemplary embodiments, the user parameter registration information 221A, 321A, 521A, 722A, 871A may not be able to be updated once being registered.

Further, in the third and forth exemplary embodiments, the output conversion formula and registration conversion formula may be constant regardless of the duration of use of the display 2C.

In the fifth exemplary embodiment, the image-quality and sound-quality database 870 of the display 2E stores the user database 321 which is the same as that of the second exemplary embodiment. The user database 321 may store the user parameter registration information 321A relating only to a user of the display 2E, and the user's user setting information may be acquired corresponding to categories of the content by the same processing as in the second exemplary embodiment.

Also, in the fourth exemplary embodiment, the content of the statistical data registration information 723A may be confirmed by the display 2D.

Further, in the first and fourth exemplary embodiments, the image-quality and sound-quality database 220, 320, 520, 720 of the server 3A to 3D may store parameters of famous commentators and the like, and may suitably transmit the parameters to the display 2A to 2D by charging or the like. With such arrangement, a content can be viewed with image-quality and sound-quality which cannot be adjusted by a user.

Further, the content output system according to an aspect of the invention may be applied to an arrangement in which a content is recorded and reproduced using a recording medium such as BD (blu-ray disc) and HD DVD (high definition DVD). The content output system may be applied to an arrangement in which an image is not displayed such as a radio or reproducer. Further, the content output system may be applied to an arrangement in which sound is not outputted such as a viewer of the image.

The above-described components are configured as programs. However, the components may be configured in other configurations, for instance, as a hardware such as a circuit board or one IC (integrated circuit). When the components are read from the program or recording medium, operation can be facilitated and usage can be easily expanded as described above.

A specific structure and procedure in carrying out the invention may be suitably modified to another structure or the like as long as an object of the invention is achieved.

### [Advantages of Exemplary Embodiments]

According to the exemplary embodiments as described above, the server 3A of the content output system 1A acquires the user parameter registration information including a user name of the display 2A and a title of the request content based on the parameter request information from the display 2A. When the image-quality and sound-quality optimum parameter is included, the server 3A acquires the image-quality and sound-quality parameter as the user's user setting information. When the server 3A cannot acquire the user's user setting information, the server 3A retrieves the user parameter registration information including another person's user name and the title of the request content. When the image-quality and sound-quality optimum parameter is included in the user parameter registration information and the image-quality and sound-quality optimum parameter relating to the other contents corresponds to the image-quality and sound-quality optimum parameter relating to the other contents of the user requesting the image-quality and sound-quality optimum parameter, the server 3A acquires an image-quality and sound-quality optimum parameter relating to the request content of another person as the another person's user setting information. Then, the server 3A transmits the user setting information of the user or another person to the display 2A.

Accordingly, the server 3A can output the request content of which image-quality and sound-quality are adjusted to meet user's preference based on the image-quality and sound-quality optimum parameter of the user. Even when the image-quality and sound-quality optimum parameter of the user does not exist in the server 3A such as when a new content is viewed, the user can view the request content adjusted to meet user's preference without setting the image-quality and sound-quality optimum parameter by himself by outputting the request content based on the image-quality and sound-quality optimum parameter of the request content set by another person having similar preference (i.e., the image-quality and sound-quality optimum parameters relating to the other contents are substantially coincident).

Thus, the server 3A can output a content of an output mode to meet user's preference without complicated operation.

### INDUSTRIAL APPLICABILITY

The invention is applicable as a content set value information acquiring device, a content output system, a content set value information acquiring method, a program thereof, and a recording medium on which the program is recorded for acquiring a content set value information relating to a content set value indicating an output mode of a content outputted by an output unit based on content data and transmitting the content set value information to an output mode controller that controls the output mode.

1. A content set value information acquiring device for acquiring a content set value information relating to a content set value indicating an output mode of a content outputted by an output unit based on content data and for transmitting the content set value information to an output mode controller that controls the output mode, the content set value information acquiring device comprising:
a request information acquirer that acquires a request information relating to the content outputted by the output unit;
a user information acquiring processor for acquiring an output mode registration information of which an information relating to the content and associated with a user of a predetermined output unit corresponds to the request information from an output mode registration information storage that stores the output mode registration information, the output mode registration information including the information relating to the content and an output mode of the content and being associated with the user of the output unit;
an another person's information acquiring processor for acquiring the output mode registration information of which the information relating to the content and associated with another person of another output unit when recognizing that the informations relating to the output mode of the output mode registration information and associated with the user of the output unit and the another person of the another output unit in which the information relating to the content does not correspond to the request information substantially correspond to each other;
a content set value information generator for generating the content set value information based on the output mode registration information acquired by the user information acquiring processor or the another person's information acquiring processor; and
a content set value information transmitter for transmitting the content set value information generated by the content set value information generator to the output mode controller corresponding to the request information.

2. The content set value information acquiring device according to claim 1, wherein
the request information and the output mode registration information include an information hierarchically indicating the content, and
the user information acquiring processor acquires the output mode registration information of which a predetermined rank including the uppermost rank of the output mode registration information and associated with the user of the output unit corresponds to the request information when all of ranks representing the content of the output mode registration information and associated with the user of the output unit correspond to the request information.

3. The content set value information acquiring device according to claim 2, wherein
the user information acquiring processor acquires the output mode registration information of which the lowermost rank corresponds to the request information out of the output mode registration information of which the predetermined rank including the uppermost rank of the output mode registration information corresponds to the request information.

4. The content set value information acquiring device according to claim 1, wherein
the content set value information generator generates the content set value information relating to the content set value set in advance for the content when the user information acquiring processor and the another person's information acquiring processor do not generate the content set value information based on the content set value information.

5. The content set value information acquiring device according to claim 1, wherein
the output unit includes a display unit for displaying an image, and
the content data includes an image data based on which the display unit displays the image as the content.

6. The content set value information acquiring device according to claim 1, wherein
the output unit includes a sound output unit for outputting a sound, and
the content data includes a sound data based on which the sound unit outputs the sound as the content.

7. The content set value information acquiring device according to claim 1, wherein
the output mode registration information includes an information relating to a type of the predetermined output unit,
the request information acquirer acquires the request information including the information relating to the type of the output unit, and
the another person's information acquiring processor acquires the output mode registration information of which the information relating to the content and associated with the another person of the another output unit when recognizing the informations relating to the output mode of the output mode registration information associated with the user of the output unit and the another user of the another output unit in which the request information does not correspond to the information relating to the content substantially correspond to each other.

8. A content output system, comprising:
a plurality of output devices connected to receive and transmit various information via a network and including the content set value information acquiring device according to claim 1, wherein
each of the output devices includes: the output unit; the output mode controller; and the output mode registration information storage that stores the output mode registration information associated with the user of the output unit,
the user information acquiring processor acquires the output mode registration information from the output mode registration information storage, and
the another person's information acquiring processor acquires the output mode registration information from the output mode registration information storage of another output device.

9. A content output system comprising:
the content set value information acquiring device according to claim 1; and
a plurality of output devices connected to receive and transmit various information via a network from and to the content set value information acquiring device, wherein
each of the output devices includes: the output unit; the output mode controller; and a request information transmitter for transmitting the request information to the content set value information acquiring device via the network,
the content set value information acquiring device includes the output mode registration information storage that stores the output mode registration information associated with users of the plurality of output devices, and
the content set value information transmitter transmits the content set value information to the output devices that has transmitted the request information via the network.

10. The content output system according to claim 9, wherein
each of the output devices includes a user set-input value information transmitter for transmitting to the content set value information acquiring device via the network a user set-input value information relating to the content set value that is set and input by a user, and
the content set value acquiring device includes an updater for updating to the user set-input value information an information relating to the output mode of the output mode registration information of which an information relating to the content and associated with a user of one of the output devices that has transmitted the user set-input value information corresponds to the request information.

11. A content output system, comprising:
the content set value information acquiring device according to claim 1; and
a plurality of output devices connected to receive and send various information via a network from and to the content set value information acquiring device, wherein
each of the output devices includes: the output unit; the output mode controller; and a request information transmitter for transmitting the request information including an information relating to a type of the output unit to the content set value information acquiring device via the network,
the content set value acquiring device includes: the output mode registration information storage that stores the output mode registration information including an information relating to a content converted value obtained by converting the content set value based on a registration conversion formula as an information relating to the output mode and associated with users of the plurality of the output devices; and an output conversion information storage that stores an output conversion information including an information relating to a type of the output unit and an output conversion formula for converting the content converted value to the content set value,
the content set value information generator generates the content set value information based on: the output conversion formula of the output conversion information of which the information relating to the type of the output unit corresponds to the request information; and the content converted value of the output mode registration information, and
the content set value information transmitter transmits the content set value information to the output device that has transmitted the request information via the network.

12. The content output system according to claim 11, wherein
each of the output devices includes a user set-input value information transmitter for transmitting to the content set value information acquiring device via the network a user set-input value information relating to the content set value that is set and input by a user, and
the content set value acquiring device includes: a registration conversion information storage that stores a registration conversion information including an information relating to the registration conversion formula and the type of the output unit; a converter that converts the content set value of the user set-input value information to the content converted value based on the registration conversion formula of the registration conversion information of which the information relating to the type of the output unit corresponds to the request information; and an updater for updating to the content converted value converted by the converter the content converted value of the output mode registration information of which an information relating to the content and associated with a user of one of the output device that has transmitted the user set-input value information corresponds to the request information.

13. The content output system according to claim 11, wherein
the registration conversion formula and the output conversion formula are set corresponding to a duration of use of the output unit.

14. The content output system according to claim 11, wherein
the content set value information generator generates the content set value information relating to the content set value obtained by a statistical processing based on: a statistically processed value obtained by the statistical processing of the content converted value of the output mode registration information of which the information relating to the content corresponds to the request information; and the output conversion formula of the output conversion information of which the information relating to the type of the output unit corresponds to the request information.

15. The content output system according to claim 14, wherein the statistically processed value is an average value.

16. The content output system according to claim 14, wherein the statistically processed value is a central value.

17. The content output system according to claim 14, wherein the statistically processed value is the content converted value having a predetermined degree.

18. A content set value information acquiring method for acquiring a content set value information relating to a content set value indicating an output mode of a content outputted by an output unit based on content data and for transmitting the content set value information to an output mode controller that controls the output mode by a computer,
the computer performing the method comprising:
acquiring a request information relating to the content outputted by the output unit;
acquiring an output mode registration information of which an information relating to the content and associated with a user of the output unit corresponds to the request information from an output mode registration information storage that stores the output mode registration information including an information relating to the content and an output mode of the content and associated with the user of the output unit;
acquiring the output mode registration information of which an information relating to the content and associated with an another person of another output unit when recognizing the informations relating to the output mode of the output mode registration information associated with the user of the output unit and the another user of the another output unit in which the information relating to the content does not correspond to the request information substantially correspond to each other;
generating the content set value information based on the acquired output mode registration information associated with the user of the output unit or the another user of the another output unit; and
transmitting the generated content set value information to the output mode controller corresponding to the request information.

19. A recording medium readable by a computer on which a content set value acquiring program for operating the computer to execute the content set value information acquiring method according to claim 18 is recorded in a computer-readable manner.

20. A recording medium readable by a computer on which a content set value information acquiring program for operating the computer to function as the content set value information acquiring device according to claim 1 is recorded in a computer-readable manner.

21. (canceled)
